(19) United States
(12) Patent Application Publication
(10) Pub. No.: US 2014/0123006 A1
(43) Pub. Date: May 1, 2014

(54) USER INTERFACE FOR STREAMING MEDIA STATIONS WITH FLEXIBLE STATION CREATION

(71) Applicant: Apple Inc., Cupertino, CA (US)

(72) Inventors: Elbert D. Chen, Cupertino, CA (US); Policarpo Wood, San Jose, CA (US); William Bachman, San Jose, CA (US); Jeffrey L. Robbin, Los Altos, CA (US)

(73) Assignee: Apple Inc., Cupertino, CA (US)

(21) Appl. No.: 13/960,139

(22) Filed: Aug. 6, 2013

Related U.S. Application Data
(60) Provisional application No. 61/718,678, filed on Oct. 25, 2012.

(51) Int. Cl. G06F 3/0482

(52) U.S. Cl. CPC G06F 3/0482
USPC 715/716

(57) ABSTRACT

User interfaces provide options for customizing a streaming media application to incorporate a personalized stations list defined by a user. For example, a user can create stations based on categories (e.g., genres or other characteristics), specific artists, and/or specific tracks. The user can select categories, artists, or tracks to be used for defining a station via a number of options, such as by searching or browsing a radio service's library of tracks; by selecting a currently playing or previously played track; and/or by selecting a track from a user's personal media library. Stations that a user has defined can be further customized based on user feedback, and stations on the user's personal stations list can be edited, deleted, and/or rearranged as the user sees fit.

### CROSS-REFERENCES TO RELATED APPLICATIONS

This application is a non-provisional of U.S. Provisional Application No. 61/718,678, filed Oct. 25, 2012, the disclosure of which is incorporated by reference in its entirety.

The present disclosure is related to the following commonly-assigned co-pending U.S. Provisional Applications: Provisional Application No. 61/718,642, filed Oct. 25, 2012; Provisional Application No. 61/714,717, filed on Oct. 16, 2012; and Provisional Application No. 61/718,667, filed on Oct. 25, 2012. The respective disclosures of these applications are incorporated by reference in their entirety.

### BACKGROUND

The present disclosure relates generally to streaming media and in particular to a user interface for streaming media with flexible station creation.

Increasingly, people are using electronic devices to purchase and consume digital content, including books, music, movies, and applications. One way of consuming digital content that is becoming more and more popular is “internet radio.” Internet radio generally refers to streaming music that is provided over the internet and/or other network connections to various computing devices, including desktop computers, laptop computers, and mobile devices, such as smart phones, tablet computers, and other mobile computing devices.

Some internet radio applications and services are similar to traditional radio services provided by broadcast radio stations, in that the music, advertisements, and/or other content that is broadcast and/or otherwise played is centrally controlled by a single entity, such as a disc jockey or “DJ,” for a relatively large number of listeners. In other internet radio applications and services, the advertisements, music, and/or other content that is broadcast and/or otherwise played is selected for and played to a narrower, and sometimes individual, audience.

For example, some internet radio systems may allow a user to create an internet radio station based on one or more content seeds. Like a traditional broadcast radio station, an internet radio station may represent a media channel via which a particular selection of songs and/or other content is provided, but for an internet radio station, the selection of songs that is provided may be defined based on the one or more content seeds. Typically, the content seeds are songs, albums, or artists that are selected by the user based on individual tastes and interests. An internet radio service then may select one or more songs for the created internet radio station based on the content seeds provided by the user. The selected songs then may be provided to the user, for instance, via a streaming network connection.

### SUMMARY

Certain embodiments of the present invention provide user interfaces for customizing a streaming media application to incorporate a personalized stations list defined by a user. For example, a user can create stations based on categories (e.g., genres or other characteristics), specific artists, and/or specific tracks. The user can select categories, artists, or tracks to be used for defining a station via a number of options, such as by searching or browsing a radio service's library of tracks; by selecting a currently playing or previously played track; and/or by selecting a track from a user's personal media library. Stations that a user has defined can be further customized based on user feedback, and stations on the user's personal stations list can be edited, deleted, and/or rearranged as the user sees fit.

In some embodiments, a computing device (e.g., a client device operable by a user) can display a graphical interface that includes a group of graphical elements (e.g., station icons) associated with remotely stored streaming media data (e.g., various stations). The user can select an element associated with a category (e.g., a genre or other characteristic of media tracks). In response, the device can provide media stream options associated with the category including an option to add one or more new media streams (e.g., create a station) and/or to further refine the definition by specifying subcategories and/or other characteristics. If the user opts to add a media stream, a new media stream associated with the category can be added to a media stream collection associated with the user (e.g., the user's personal stations list).

In some embodiments, the computing device can display a graphical interface that includes a group of graphical elements associated with a user's personal media library, which can include locally stored media data and/or cloud-based media data in any combination. When the user selects one of the graphical elements (e.g., a track from the user's library), the device can present to the user one or more media stream options, including an option to add a new media stream associated with remotely stored streaming media data based on the selected graphical elements. These options can be presented in an overlay menu or the like. If the user opts to add the new media stream, a new media stream associated with the remotely stored streaming media data can be added to a media stream collection maintained for the user.

In some instances, the user can select the option to add the new media stream while the media data from the local source is being presented to the user. Where this occurs, upon adding a new media stream, the computing device can transition from presenting remotely stored streaming media data associated with the new media stream. The transition can be seamless; for example, the computing device can continue playing the track from the locally stored data, then begin presenting remotely stored streaming data at the end of the track.

When a new media stream is added, the new stream can begin playing without waiting for further user input. Whenever the user next views a list of available media streams, the list can include the new stream.

In some embodiments, the user can also view and interact with history data related to previously streamed media content, and the interaction can include adding a new media stream based on an element of previously streamed media content (e.g., a particular track or characteristics of a particular track).

The following detailed description together with the accompanying drawings will provide a better understanding of the nature and advantages of the present invention.

### BRIEF DESCRIPTION OF THE DRAWINGS

FIG. 1 is a simplified block diagram of a system for providing a network-based radio service to a user according to an embodiment of the present invention.

FIG. 2 is a flow diagram of a process for initializing stations according to an embodiment of the present invention.

FIG. 3 illustrates a graphical user interface for a radio application according to an embodiment of the present invention.

FIG. 4 illustrates a now-playing interface according to an embodiment of the present invention.

FIG. 5 illustrates a new-station selection interface according to an embodiment of the present invention.

FIG. 6 illustrates an interface for refining a category-based station definition according to an embodiment of the present invention.

FIG. 7 illustrates a station creation interface according to an embodiment of the present invention.

FIG. 8 is a flow diagram illustrating a process for station creation according to an embodiment of the present invention.

FIG. 9 is a flow diagram of a process for searching a media library according to an embodiment of the present invention.

FIG. 10 is a flow diagram of a process for new station processing according to an embodiment of the present invention

FIG. 11 illustrates an interface that provides station creation and customization from a now-playing interface according to an embodiment of the present invention.

FIG. 12 illustrates a history interface according to an embodiment of the present invention.

FIG. 13 illustrates another history interface according to an embodiment of the present invention.

FIG. 14 illustrates an interface for a media management application according to an embodiment of the present invention

FIG. 15 illustrates another interface for a media management application according to an embodiment of the present invention.

FIG. 16 is a flow diagram of a process for creating a media station based on a track in a user's personal media library according to an embodiment of the present invention.

FIG. 17 illustrates a user interface for editing stations according to an embodiment of the present invention.

FIG. 18 illustrates another user interface for editing stations according to an embodiment of the present invention.

### DETAILED DESCRIPTION

Certain embodiments of the present invention provide user interfaces for customizing a streaming media application to incorporate a personalized stations list defined by a user. For example, a user can create stations based on categories (e.g., genres or other characteristics), specific artists, and/or specific tracks. The user can select categories, artists, or tracks to be used for defining a station via a number of options, such as by searching or browsing a radio service's library of tracks; by selecting a currently playing or previously played track; and/or by selecting a track from a user's personal media library. Stations that a user has defined can be further customized based on user feedback, and stations on the user's personal stations list can be edited, deleted, and/or rearranged as the user sees fit.

As used herein, the term “radio” refers generally to a streaming media service that allows a user to select from multiple coexisting playlists (or queues) of media tracks (e.g., audio tracks such as songs). Each playlist is associated with a “station,” and a user can select a station and thereby experience a particular playlist of media tracks. At any time the user can change to another station and experience a different playlist. The stations can be designed to play continuously without end; for example, if the end of the last track in the playlist is reached, playback can continue by replaying the first track in the playlist. In some embodiments, a station's playlist can be periodically refreshed by adding new tracks and/or removing tracks, thereby reducing repetition. In general, the playlists for different stations can include different tracks, although a given track may appear in multiple station playlists depending on how stations are defined and/or how tracks are selected for a particular station's playlist.

In embodiments described herein, media presentation can be handled using streaming technology, in which a source device can provide media content to a destination device via a network, with the destination device retaining the content in its memory long enough to present it to the user, then deleting the content. However, the present invention is not limited to streaming, and some or all of the media content being presented can be stored persistently on the presenting device.

Further, although the following description makes specific reference to presentation of audio content (e.g., songs), those skilled in the art with access to the present disclosure will recognize that similar techniques can be adapted for other types of media content (e.g., video, books, slide shows, or the like).

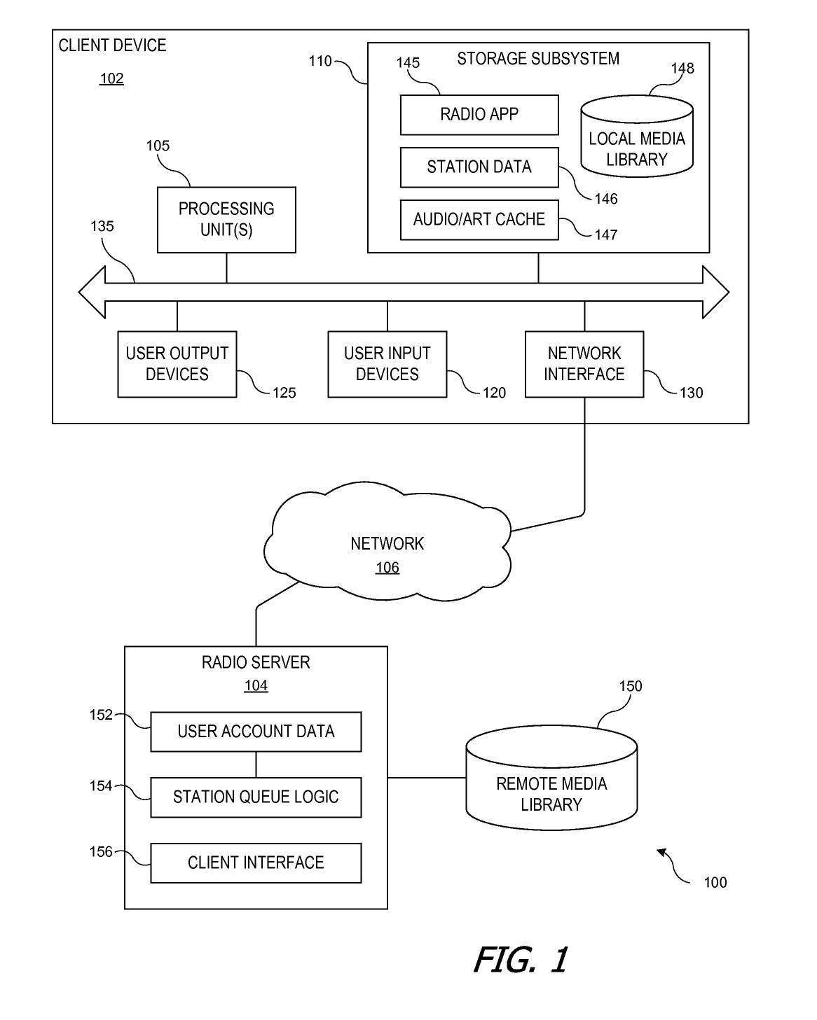

FIG. 1 is a simplified block diagram of a system 100 for providing a network-based radio service to a user according to an embodiment of the present invention. System 100 can include one or more client devices 102 that communicate with a radio server 104 via a network 106 (e.g., the Internet).

Client device 102 can be implemented as any of various computing devices or computer systems, including, e.g., a desktop or laptop computer, tablet computer, smart phone, personal data assistant (PDA), set-top box for delivering media to an audio/video display system, or any other type of computing device, not limited to any particular form factor. Client device 102 can include processing unit(s) 105, storage subsystem 110, input devices 120, user output devices 125, and network interface 130, all communicatively coupled to bus 135.

Processing unit(s) 105 can include a single processor, which can have one or more cores, or multiple processors. In some embodiments, processing unit(s) 105 can include a general-purpose primary processor as well as one or more special-purpose co-processors such as graphics processors, audio processors, other digital signal processors, or the like. In some embodiments, some or all processing units 105 can be implemented using customized circuits, such as application specific integrated circuits (ASICs) or field programmable gate arrays (FPGAs). In some embodiments, such integrated circuits execute instructions that are stored on the circuit itself. In other embodiments, processing unit(s) 105 can execute instructions stored in storage subsystem 110.

Storage subsystem 110 can include various memory units such as a system memory, a read-only memory (ROM), and a persistent storage device. The ROM can store static data and instructions that are needed by processing unit(s) 105 and other modules of client device 102. The persistent storage device can be a read-and-write, non-volatile memory unit that stores instructions and data even when computer system 102 is powered down. Some embodiments of the invention can use a mass-storage device (such as a magnetic or optical disk or flash memory) as a persistent storage device. Other embodiments can use a removable storage device (e.g., a floppy disk, a flash drive) as a persistent storage device. The system memory can include volatile read-and-write memory devices, such as dynamic random access memory. The system memory can store some or all of the instructions and data that the processor needs at runtime.

Storage subsystem 110 can include any combination of computer readable storage media including semiconductor memory chips of various types (DRAM, SRAM, SDRAM, flash memory, programmable read-only memory) and so on. Magnetic and/or optical disks can also be used. In some embodiments, storage subsystem 110 can include removable storage media that can be readable and/or writeable; examples of such media include compact disc (CD), read-only digital versatile disc (e.g., DVD-ROM, dual-layer DVD-ROM), read-only and recordable Blue-Ray® disks, ultra density optical disks, flash memory cards (e.g., SD cards, mini-SD cards, micro-SD cards, etc.), magnetic “floppy” disks, and so on. The computer readable storage media in subsystem 110 do not include carrier waves and transitory electronic signals passing wirelessly or over wired connections.

In some embodiments, storage subsystem 110 can store one or more software programs to be executed by processing unit(s) 105, such as a radio application 145. “Software” refers generally to sequences of instructions that, when executed by processing unit(s) 105 cause client device 102 to perform various operations, thus defining one or more specific machine implementations that execute and perform the operations of the software programs. The instructions can be stored as firmware residing in read-only memory and/or applications stored in persistent storage that can be read into memory for processing by a processor. Software can be implemented as a single program or a collection of separate programs or program modules that interact as desired. Programs and/or data can be stored in non-volatile storage and copied in whole or in part to volatile working memory during program execution. From storage subsystem 110, processing unit(s) 105 can retrieve program instructions to execute and data to process in order to execute various operations described herein.

Storage subsystem 110 can also store data that is usable in connection with various stored software programs. For example, storage subsystem 110 can store data used by radio application 145, such as station data 146 for one or more internet radio stations (which can be obtained from radio server 104 as described below), and a cache 147 to temporarily store audio and/or artwork associated with the internet radio stations.

A user interface can be provided by one or more user input devices 120 and/or one or more user output devices 125. Input devices 120 can include any device via which a user can provide signals to client device 102; client device 102 can interpret the signals as indicative of particular user requests or information. In various embodiments, input devices 120 can include any or all of a keyboard, touch pad, touch screen, mouse or other pointing device, scroll wheel, click wheel, dial, button, switch, keypad, microphone, and so on. Some or all of user input devices 120 can be implemented as a remote control device that communicates wirelessly with client device 102.

User output devices 125 can include a display to display images generated by client device 102 and can include various image generation technologies, e.g., a cathode ray tube (CRT), liquid crystal display (LCD), light-emitting diode (LED) including organic light-emitting diodes (OLED), projection system, or the like, together with supporting electronics (e.g., digital-to-analog or analog-to-digital converters, signal processors, or the like). The display can be within the housing of client device 102 or an external device connected by a suitable connector (e.g., HDMI) to a driver circuit within the housing of client device 102 that provides displayable image data. Some embodiments can include a device such as a touchscreen that functions as both input and output device. User output devices 125 can also include audio output devices operable to deliver sound to a user, such as speakers, speaker jacks, a headphone jack, or the like. In some embodiments, other user output devices 125 can be provided in addition to or instead of display and/or audio devices. Examples include indicator lights, speakers, tactile “display” devices, printers, and so on.

In some embodiments, user input device 120 and user output devices 125 can interoperate to provide a graphical user interface, in which visible image elements in certain areas of a display device (one of user output devices 125) are defined as active elements or control elements that the user can actuate by operating user input devices 120. For example, the user can manipulate a user input device to position an on-screen cursor or pointer over the control element, then click a button to actuate the element. Alternatively, the user can actuate a control element on a touchscreen device by touching it (e.g., with a finger or stylus). In some embodiments, the user can speak one or more words associated with the control element in order to actuate it (the word can be, e.g., a label on the element or a function associated with the element). In some embodiments, user gestures on a touch-sensitive device can be recognized and interpreted as input commands to actuate various controls; these gestures can be but need not be associated with any particular area within the display. In some embodiments, the user can manipulate a remote control device to highlight and select a displayed control element. Other user interfaces can also be implemented.

Network interface 130 can provide voice and/or data communication capability for client device 102. In some embodiments, network interface 130 can include radio frequency (RF) transceiver components for accessing wireless voice and/or data networks (e.g., using cellular telephone technology, advanced data network technology such as 3G, 4G or EDGE, Wi-Fi (IEEE 802.11 family standards, or other mobile communication technologies, or any combination thereof), GPS receiver components, and/or other components. In some embodiments, network interface 130 can provide wired network connectivity (e.g., Ethernet) in addition to or instead of a wireless interface. Network interface 130 can be implemented using a combination of hardware (e.g., antennas, modulators/demodulators, encoders/decoders, and other analog and/or digital signal processing circuits) and software components.

Bus 135 can include various system, peripheral, and chipset buses that communicatively connect the various components of client device 102. For example, bus 135 can communicatively couple processing unit(s) 105 with storage subsystem 110. Bus 135 also connects to input devices 120 and output devices 125. Bus 135 also couples client device 102 to a network through network interface 130. In this manner, client device 102 can participate in a network 106 that can interconnect multiple computer systems (e.g., a local area network (LAN), a wide area network (WAN), an Intranet, or a network of networks, such as the Internet. Any or all components of client device 102 can be used in conjunction with the invention.

Some embodiments include electronic components, such as microprocessors, storage and memory that store computer program instructions in a computer readable storage medium. Many of the features described in this specification can be implemented as processes that are specified as a set of program instructions encoded on a computer readable storage medium. When these program instructions are executed by one or more processing units, they cause the processing unit(s) to perform various operation indicated in the program instructions. Examples of program instructions or computer code include machine code, such as is produced by a compiler, and files including higher-level code that are executed by a computer, an electronic component, or a microprocessor using an interpreter.

Through suitable programming, processing unit(s) 105 can provide various functionality for client device 102. For example, processing unit(s) 105 can execute radio application 145. Radio application 145 can provide various functionality such as the ability to retrieve playlists of tracks associated with different stations from radio server 104; to present tracks from a selected station to the user (e.g., by retrieving track data from a local media library 148 or from a remote media library 150 and converting the track data to analog audio output); and to receive and process user input associated with controlling operation of radio application 145, such as station creation, station selection, purchasing tracks, etc. Examples of user interfaces for radio application 145 are described below.

Radio server 104 can be a computer system incorporating similar components to client device 102 (e.g., processors, storage subsystems, input/output devices, network interfaces) and can have various form-factors. For example, radio server 104 can be implemented using scalable server technologies (e.g., blade servers and/or server farms) to manage large numbers of users and/or large volumes of data. Radio server 104 can include storage for user account data 152, software implementing station queue logic 154, and a client interface 156. In some embodiments, radio server 104 has access to a remote media library 150 (“remote” in the sense that it is remote from client device 102), either directly (as shown) or via network 106. Remote media library 150 can be a large library containing thousands or millions of tracks that can potentially be streamed to client device 102. Remote library 150 can include track content (e.g., digital audio) as well as metadata describing each track (e.g., title, artist, album, year, genre, subgenre, tempo, featured instruments, audio characteristics, mood, popularity) and associated “artwork” (typically one or more image files, which can be, e.g., images of album covers or the like) for some or all of the tracks.

In operation, radio server 104 can provide a cloud-based streaming radio service for a user. For example, radio server 104 can maintain user account data 152 for a number of user accounts. The user account data for a given user can include user-identification credentials (e.g., a username and password), as well as definitions for one or more stations associated with the user.

Stations can be defined in various ways. In some instances, a user can identify a seed song, and the station can be defined by the seed song and/or some combination of characteristics of the seed song (e.g., artist, genre, year of release, tempo, featured instruments, audio characteristics, mood, etc.). In other instances, a user can define a station based on desired characteristics (e.g., a genre such as Electronica, a sub-genre such as Chill, a particular artist, a date range such as “80's music,” a mood such as happy, etc.). In addition, some embodiments allow a user to further customize a station after it has initially been defined. For instance, as described below, while listening to a particular station, the user can indicate liking or disliking a particular track, and the user's likes and dislikes can be provided to radio server 104, which can use the feedback to influence future track selections for that station or across multiple stations.

In some instances, a provider of radio service 104 can also define various “featured” stations, e.g., stations associated with particular musical genres, lifestyles, moods, or the like. In some instances, a featured station can be sponsored by a third party. Featured stations can be associated with a particular user based on user selection from a menu of featured stations, or they can be associated based on decisions made by radio server 104, e.g., based on the user's previous listening and/or media purchasing behavior. In some embodiments, multiple users can be associated with the same featured station, and each user can receive the same playlist or stream for that station at any given time.

Station queue logic 154 can be configured to generate a playlist, or queue, for each radio station associated with a given user. For example, if a station is defined with reference to a seed song (or characteristics thereof), station queue logic 154 can be configured to identify other songs in remote media library 150 with characteristics similar to the seed song and create a playlist from the identified songs; the playlist may or may not include the seed song. In the case of a featured station, station queue logic 154 may simply read a preprogrammed playlist that can be defined by an operator of radio server 104 and/or by a third-party sponsor of the station. The playlist for a given station generally includes some number of “tracks,” where the term track can include any discrete block of recorded media content such as a song, a lecture, a segment of a recorded performance, an advertisement, etc., and a playlist can be refreshed or expanded at any time, allowing a station to continue to play different content (or different mixes of content) indefinitely.

Client interface 156 can manage communications with one or more user computers 102. For example, client interface 156 can receive user credentials for a particular user from client device 102 via network 104, validate the credentials, and provide station information from user account data 152 to client device 102. Client interface 156 can also invoke station queue logic 154 to generate playlists for one or more stations for a particular user and can communicate the playlists to client device 102. In addition, client interface 156 can provide track content and metadata from remote media library 150 to client device 102 on request. In some embodiments, access to track content and metadata can be limited to client devices 102 that have established a session with radio server 104 using valid user credentials.

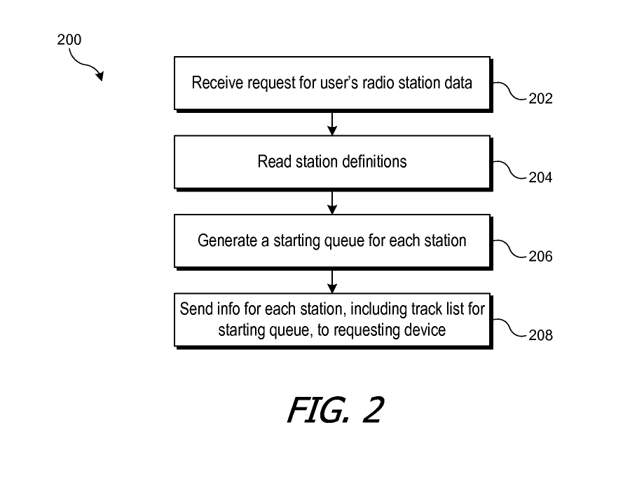

In some embodiments, when a client device 102 establishes a session for a particular user account with radio server 104, radio server 104 proceeds to initialize all of the stations defined for that user account. FIG. 2 is a flow diagram of a process 200 for initializing stations according to an embodiment of the present invention. Process 200 can be executed, e.g., by radio server 104 of FIG. 1.

At block 202, radio server 104 can receive a request for a user's station data. For instance, client device 102 can provide the user's credentials and indicate that the user has launched radio application 145. At block 204, radio server 104 can read the station definitions for the user (e.g., from user account data 152).

At block 206, radio server 104 can generate a starting playlist for each station defined for the user, e.g., by invoking station queue logic 154. In general, the length of a station's playlist can be established in any manner desired and can be varied over time, e.g., by dynamically adding and/or removing tracks. For example, to avoid repetition, it may be desirable to define a long playlist (e.g., 24 hours' worth of tracks). However, in practice a given user may have dozens or hundreds of stations defined, and generating a 24-hour playlist for every station is likely not to be necessary. Accordingly, the starting playlist can be relatively short, e.g., 10 tracks, 12 tracks, 15 tracks, or the like. (In some embodiments, the starting playlist for a station does not include advertisements.) At block 208, radio server 104 can provide station information, including the starting playlist generated for each station, to client device 102. Other information, such as station names or station identifiers (e.g., the title and/or artist for the station's seed song) can also be provided. With this information, client device 102 can initialize a user interface of radio application 145 to provide station information to a user. Examples of user interfaces for radio application 145 are described below. It will become apparent that the user interfaces described herein can be used independently of the details of generating the station playlists; accordingly, further description of generating station playlists is omitted.

It will be appreciated that network-based radio system 100 is illustrative and that variations and modifications are possible. Client device 102 can have other capabilities not specifically described here (e.g., mobile phone, global positioning system (GPS), power management, one or more cameras, various connection ports for connecting external devices or accessories, etc.). Further, while the components of system 100 have been described with reference to particular blocks, it is to be understood that these blocks are defined for convenience of description and are not intended to imply a particular physical arrangement of component parts. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Embodiments of the present invention can be realized in a variety of apparatus including electronic devices implemented using any combination of circuitry and software.

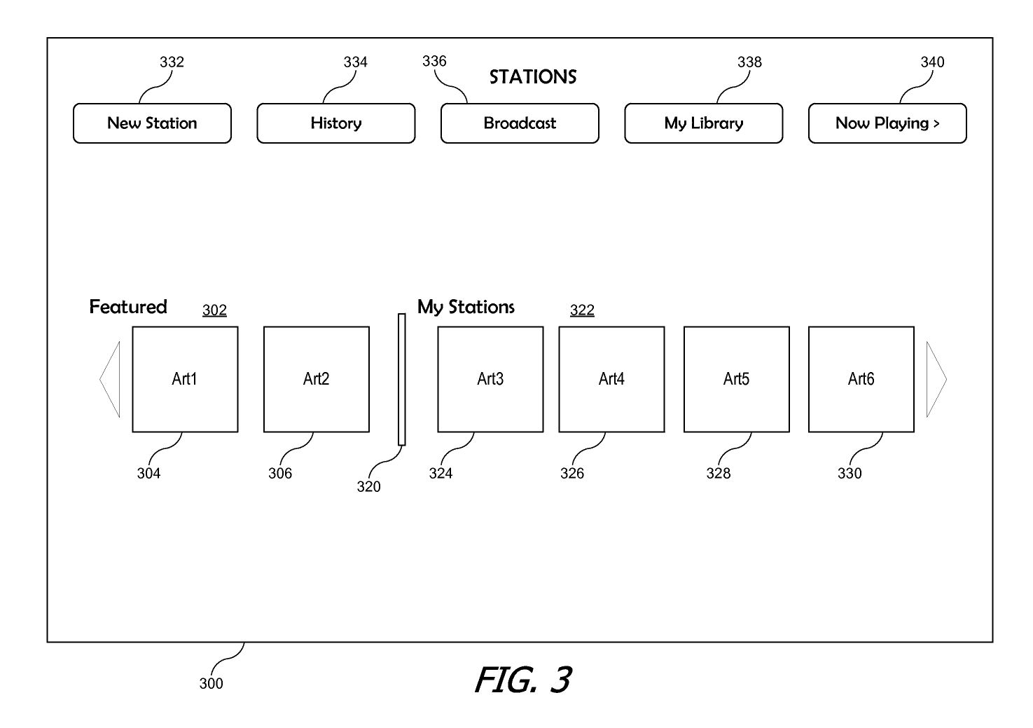

FIG. 3 illustrates a graphical user interface (GUI) 300 for a radio application according to an embodiment of the present invention. Radio GUI 300 can be implemented, e.g., on client device 102 of FIG. 1 executing radio application 145. In some embodiments, client device 102 can be implemented as a set-top box that is controlled by a remote control device that communicates wirelessly with the set-top box. A user can operate GUI 300 by manipulating the remote control device. For example, the user can navigate a cursor (e.g., a highlighted area on screen) to a desired control element by manipulating control elements (e.g., buttons, dials, trackpad) on the remote control device and actuate the control element by manipulating a selection control element (e.g., a select button) on the remote control device. The user can also navigate between GUI 300 and other GUI screens using control elements on the remote control device. In some embodiments, the remote control device can be a wand-type controller that is equipped with motion sensors, and movement of the entire remote control device can be interpreted as user input.

Where a remote control device is provided, some controls can be implemented via the remote control device regardless of whether a corresponding graphical control element is displayed on GUI 300 or any other GUI screen. For example, a user may be able to play, pause, skip or restart media content even if no playback controls are shown on the screen.

GUI 300 can provide options for a user to browse and play various media content streams (also referred to as stations). For example, featured stations section 302 can include icons 304, 306 representing featured stations. (As described above, featured stations may present playlists of content that are programmed by a radio-service operator or third party acting as a DJ.) Icons 304, 306 can contain artwork associated with the corresponding station (e.g., an album cover associated with an artist featured on the station, a logo or other graphic associated with the station or a sponsor of the station), information about the station (e.g., text providing a station name, description, and/or other information), or the like. In some embodiments, each of icons 304, 306 can initially present artwork and a station name, and a user can manipulate a control (e.g., on the remote control) to view additional information about the station in an overlay window, drop-down box, or the like. The user can select a featured station and listen to the corresponding playlist (or content stream), e.g., by navigating a cursor (not shown) to the icon corresponding to the desired station and operating a selection control (e.g., a select button on a remote control).

User-defined stations region 322, which can be separated by featured stations section by a vertical bar 320 or other visual indicator, can include icons 324-330 representing user-defined stations and/or other stations that the user has selected for inclusion in personal stations list. As described below, a user can operate GUI 300 and related interface screens to create new stations according to her taste; the user can also add predefined stations (e.g., featured stations) to user-defined stations region 322. Each station that the user has defined or added to a personal stations list can be represented by an icon (e.g., icons 324-330). Icons 324-330 can contain artwork associated with the corresponding station (e.g., an album cover associated with an artist featured on the station, a logo or other graphic associated with the station or a sponsor of the station), information about the station (e.g., text providing a station name, description, and/or other information), or the like. In some embodiments, each of icons 324-330 can initially present artwork and a station name, and a user can manipulate a control (e.g., on the remote control) to view additional information about the station in an overlay window, drop-down box, or the like. The user can select a user-defined station and listen to the corresponding playlist (or content stream), e.g., by navigating a cursor (not shown) to the icon corresponding to the desired station and operating a selection control.

The number of featured stations in region 302 and/or the number of user-defined stations in region 322 can be limited or not as desired. In particular, the number of stations need not be constrained by the available space in regions 302 and 322. In some embodiments, icons 304, 306, and 324-330 form a scrollable list or array, and the user can operate onscreen control elements and/or control elements on a remote control device to scroll the list or array and view all of the stations in the personal stations list. During scrolling, vertical bar 320 can move together with icons 304, 306, and 324-330, providing a visual separation between featured stations and user-defined stations. In some embodiments, icons for featured stations and user-created stations can be presented in any order desired, and a visual separator is not required.

Other controls can also be provided to facilitate user interaction with radio application 145. For example, GUI 300 includes new station button 332, history button 334, broadcast button 336, library button 338, and now-playing button 340. New station button 332 can be selected to launch a station creation interface, examples of which are described below, allowing the user to add stations to user-defined stations region 322. History button 334 can be selected to allow the user to view information about tracks previously played. Broadcast button 336 can be selected to allow the user to interact with broadcast media sources. Library button 338 can be selected to allow the user to access a personal media library (e.g., media library 148 of FIG. 1 or a cloud-based media library). Now playing button 340 can be selected to allow the user to view information about the currently playing track.

GUI 300, like all other interfaces described herein, is illustrative and variations and modifications are possible. Different controls and combinations of graphical control elements can be provided, and station options can be organized differently; for instance, listings of featured stations and/or genre-based stations can be omitted from GUI 300.

In some embodiments, when the user selects a station to play (e.g., any of icons 304, 306, or 324-330), or when the user operates now-playing button 340, GUI 300 is replaced with a now-playing interface that provides information about the currently playing track and/or station.

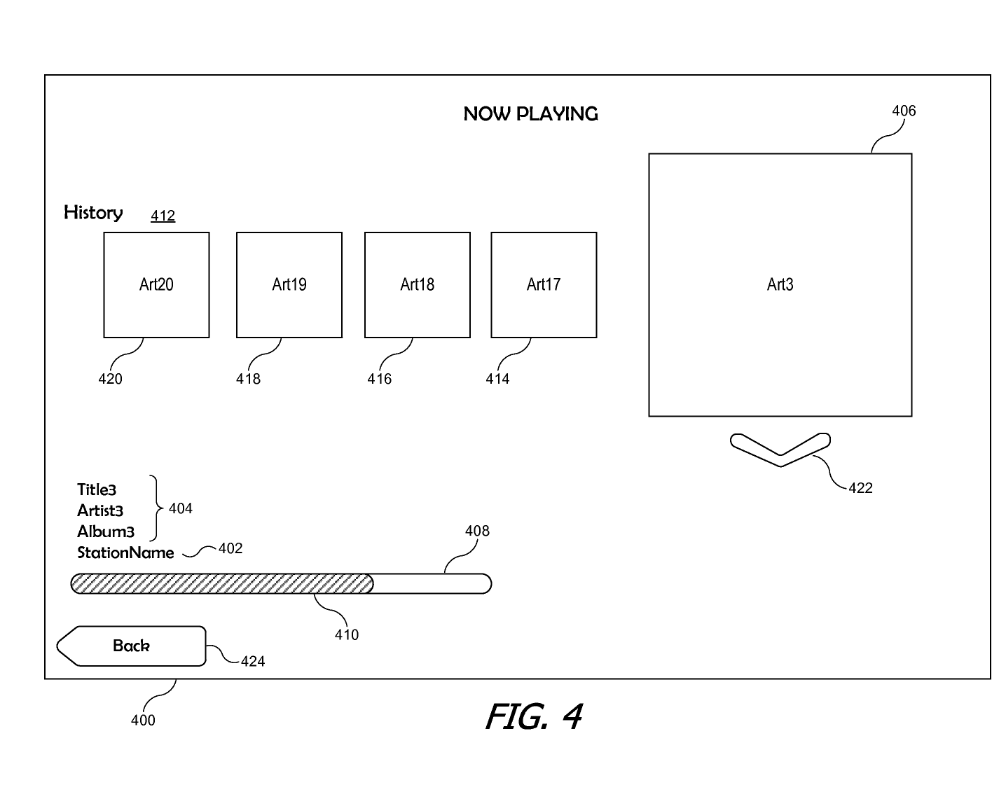

FIG. 4 illustrates a now-playing interface 400 according to an embodiment of the present invention. Interface 400 provides information about the currently playing station and track. For example, a station name 402 can be displayed, along with track identifying information 404 (e.g., track title, artist name, album name) and artwork 406 associated with the currently playing track (e.g., an album cover for an album that includes the currently playing track). As described above, track information 404 and artwork 406 can be obtained from radio server 104, along with the streamed content of the track. Progress bar 408 can be used to represent the progress of playing the track, with filled region 410 gradually advancing to fill in progress bar 408 as the track is played.

History region 412 can provide information about recently played tracks for the current station or for all stations, depending on implementation. In some embodiments, tracks are displayed in chronological order, with the most recently played track being represented by icon 414 (at the right end of the row) and increasingly less recently played tracks being represented by icons 416, 418, 420 in order from right to left. In some embodiments, icons 414-420 include artwork associated with each previously-played track, which can be the same artwork that was displayed as artwork 406 when the previously-played track was playing. The icons can also include track-identifying information such as title, artist, and album. When a track ends, an animated transition can be used to move the artwork for the completed track from the location of icon 406 to the location of icon 414, reducing its size, while other artwork shifts to the left. In some embodiments, the viewable history is not limited to the number of icons visible in history region 412; the visible icons 414-420 can be part of a scrollable list or array of icons, and the user can scroll the list to view older tracks in the history.

In some embodiments, a user can select icon 406 or caret 422 (depending on implementation) to open an overlay menu of options, examples of which are described below. Similarly, in some embodiments a user can select a track from the history list in region 412 and obtain various options, examples of which are described below.

Now-playing interface 400 can also include other control elements for interacting with a currently playing track, such as playback controls (not shown) operable to play, pause, skip, and/or restart the current track. Other examples include rating buttons, options to access additional information about the track or artist, options to view content related to the current track (e.g., a particular album or artist) in a media store application, and so on. In some embodiments, some or all of these controls appear in an overlay menu when the user selects caret 422 or icon 406. Such controls can also be implemented on a remote control device, and graphical control elements are not required.

Other graphical control elements can include navigation controls operable to navigate between various interface screens. For example, back button 424 can be operated to return to displaying the interface screen that was presented prior to displaying now-playing interface 400. In some embodiments, playback and/or navigation controls can be implemented on a remote control device and need not be presented as visible elements in the GUI screens.

As noted above with reference to FIG. 3, a user can define and/or select stations to be added to user-defined stations region 322 in GUI 300, thereby customizing the radio experience. Examples of interfaces for station creation will now be described.

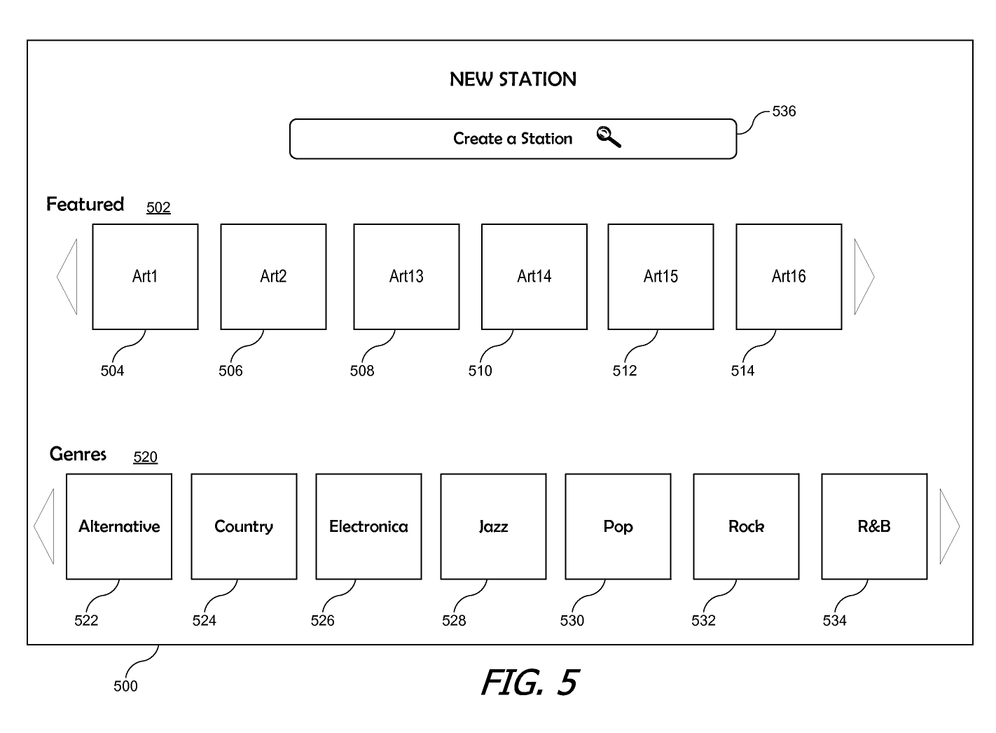

As one example, a user can create a station by selecting new station button 332 in GUI 300. In response to this selection, GUI 300 can be replaced with a new-station selection interface, an example of which is shown as interface 500 in FIG. 5.

Interface 500 can include a region 502 listing featured stations that have been defined by a provider of radio service 104 or a third party as described above. A user can view the list of featured stations, represented as icons 504-514. Like the icons in GUI 300 of FIG. 3, icons 504-514 can include artwork, station names, and/or other information as desired. As in GUI 300, the icons in region 502 can be part of a larger array that can be scrollable to allow the user to view additional options.

In some embodiments a user can select a station from region 502 and activate an overlay or drop-down box that provides additional information about the station (e.g., representative song titles, artists, etc.). For instance, the user can move a cursor to highlight an icon, then press and hold a select button on an input device to view the overlay information.

The user can also move a cursor to highlight a station in region 502 and select that station to be added to the user's list of stations in region 322 of FIG. 3. For example, adding a station can be done by clicking a select button on an input device. In the case of a featured station, the new station can appear to the left of vertical bar 320. The newly added station can be placed at the beginning of the list, so that in FIG. 3, the new station would appear at the position of icon 304, while any previously added stations would be shifted over one position. (Vertical bar 320 can shift as well, so that all featured stations are displayed to the left of the bar while user-defined stations are to the right of the bar.) In addition, radio application 145 can notify radio server 104 that the user has added the station to the user's station list. Radio server 104 can add the new station to user account data 152 so that the new station persists in the user's list. In some embodiments, radio server 104 can also provide a playlist for the new station to radio application 145. In embodiments where radio application 145 receives playlists for featured stations and/or genre-based stations at startup, server 104 may provide an updated or expanded playlist for the particular station that is being added to the user's list.

Interface 500 can also include a region 520 listing options for creating category-based (e.g., genre-based) stations that have been defined by the provider of radio service 104. In some embodiments, the provider of radio service music or other media content can classify available content into various categories. For example, music can be classified into genres such as Alternative, Rock, Country, Classical, Jazz, Pop, R&B, Hip-Hop, and so on. Other categories for music can be defined, e.g., based on time periods when the music was written or recorded, moods associated with or expressed by the music, tempo, orchestration, and/or any other known properties of music in remote media library 150. While genres are used in this description as an example of a categorization system, those skilled in the art with access to the present disclosure will recognize that other categorization systems can be substituted.

Where a provider of radio server 104 has classified music according to genre, each icon 522-534 in region 520 can correspond to a different genre and can include artwork and/or the name of the genre. The artwork can include, e.g., a representative album cover, an image suggestive of the genre (e.g., an orchestra for Classical, saxophone for Jazz, electric guitar for Rock, etc.), and/or a stylized rendition of the genre name. The number of genre-based stations that can be made available to a user is not constrained by the available space in region 520; in some embodiments, icons 522-534 can be part of a scrollable list or array, and the user can operate various controls to scroll the list or array and view selectable icons for different genres.

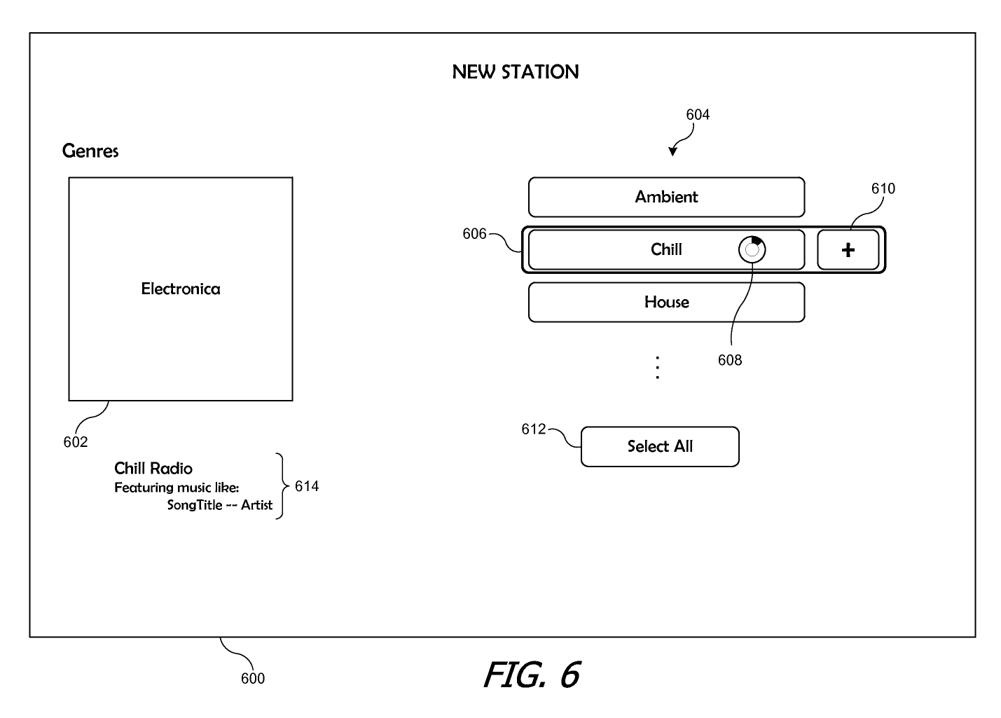

The user can operate an input device to select a genre icon in region 520. In some embodiments, if the user selects a genre icon from region 520, the user may be provided options to further customize the station, e.g., by selecting a subgenre and/or specifying additional properties. FIG. 6 illustrates a subgenre selection interface 600 that can be displayed when the user selects a genre (e.g., icon 526) from region 520 according to an embodiment of the present invention.

In interface 600, the selected genre can be identified by a large icon 602 at the left (e.g., an enlarged version of the selected icon from region 520 of FIG. 5). At the right is a list 604 of subgenres defined within selected genre 602. As the user moves a screen cursor 606 to highlight different subgenres, options can be presented to preview or create a station for the corresponding subgenre.

Preview icon 608, which can be displayed for a highlighted subgenre, can be actuated to play a sample of music in the highlighted subgenre. The sample can include a portion of a track or shorter portions of multiple tracks. In some embodiments, when a subgenre is highlighted, station information 614 for the subgenre can be presented. Station information 614 can include, e.g., a station name (which can incorporate the subgenre name, such as “Chill Radio”) and information identifying a specific track (or tracks) that are included in the sample. In some embodiments, station information 614 appears while the preview sample is playing, e.g., only if the user actuates preview icon 608.

Create icon 610 can be actuated to create a station for the highlighted subgenre and add the station to the user's station list in region 322 of FIG. 3. In some embodiments, interface 600 can also include a control 612 that is operable to select all subgenres for the new station. Further customization can also be provided, e.g., by allowing the user to select multiple subgenres for a single genre-based station.

In some embodiments, interface 600 can also provide other customization options. For instance, in addition to or instead of selecting subgenres, a user can select desired properties in relation to other categories, such as tempo, mood, orchestration, time period, and so on. Interface 600 can be modified as desired to allow the user to customize a station based on any property or characteristic of media tracks for which radio server 104 has information.

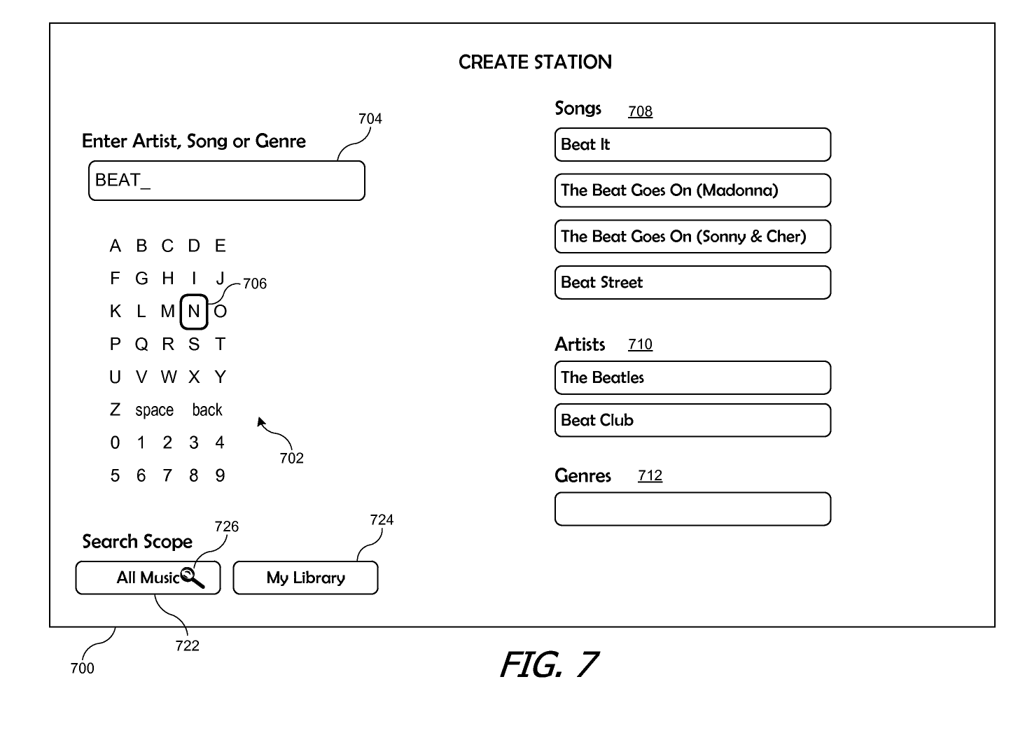

Referring again to FIG. 5, in addition to selecting from predefined stations, interface 500 can also allow the user to create a customized station, e.g., by selecting create button 536. FIG. 7 illustrates a station creation interface 700 that can be displayed when the user selects create button 536 of interface 500 according to an embodiment of the present invention. In this example, station creation interface 700 allows the user to search for song titles, artists, and genres using a single query.

Character menu 702 allows the user to enter a query by selecting characters; the selected characters can appear in text box 704. In some embodiments, the user navigates a cursor 706 to a desired character, then selects the character by operating an input control. Other input interfaces can also be provided, and any set of characters can be supported.

In this example, searching can be performed iteratively as each character is entered. For example, radio application 145 can send a query to radio server 104 including all characters that have been entered into text box 704 and receive search results (lists of hits for titles, artist names, and genres). In some embodiments, the query is sent to radio server 104 only after the user has typed multiple characters (e.g., two or three characters), and additional characters can be used by radio application 145 to filter the results received from radio server 104. Accordingly, it is not necessary for radio application 145 to send a new query to radio server 104 every time a new character is added to the search criteria; radio application 145 can perform filtering locally once the initial lists of hits are obtained. Other implementations can also be used. For example, a “go” control can be provided, and search queries can be sent only when the user activates the go control.

The search can be based on the character string entered by the user. In some embodiments, the search can be a search for titles, artist names and genres (or categories) that begin with the character string; stop words such as “The” or “A” can be ignored in the search (e.g., “The Beat Goes On” can match a search for “starts with BEAT”). In other embodiments, the search can be for titles, artist names, and genres that contain any word beginning with the character string (e.g., “We Got the Beat” can match a search for “contains BEAT”). Some embodiments allow the user to select whether to perform a “starts with” search or a “contains” search on a case-by-case basis or set a preference for one type of search over the other.

As noted above, in some embodiments, the user can have a personal media library (e.g., local media library 148 of FIG. 1), and searches can be performed on the user's personal media library in addition to or instead of a central library associated with radio server 104. For example, the user can choose the search scope by selecting button 722 to search the central library associated with radio server 104 or button 724 to search within the user's personal media library. Icon 726 or other indicia (e.g., color changes) can be used to show which option is currently selected.

Search results can be shown in region 708, which shows song titles that match the search string; region 710, which shows artist names that match the search string; and region 712 which shows genres that match the search string. Each region 708, 710, 712 can present a scrollable list of search hits, and at any time the user can scroll any of the lists and make a selection.

If the user selects a song from region 708 or artist from region 710, a custom station can be created using the selected song or artist as a seed. For example, radio application 145 can send a request to radio server 104 to generate a playlist using the selected song or artist as a seed. Radio application 145 can also notify radio server 104 that the user has added the station to the user's station list, and radio server 104 can update user account data 152 accordingly.

If the user selects a genre (or category) from region 712, a genre-based station can be created as described above with reference to region 520 of FIG. 5. For example, the display can transition to subgenre selection screen 600 of FIG. 6, allowing the user to select one or more subgenres (or all subgenres) to be included in the new station.

When the user selects or creates a new station using any of interfaces 500, 600, and/or 700, the new station can be added to the user's personal stations list in region 322 of GUI 300. In some embodiments, in addition to adding the station to the user's station list in region 322, the newly added station can begin to play. Accordingly, once the new station has been defined using interfaces 500, 600 and/or 700, the display can transition to now-playing interface 400 of FIG. 4 to show the newly added station playing. Alternatively, the display can transition back to GUI 300 of FIG. 3 to show the new station being inserted into region 322 (e.g., via an animated transition); the new station can begin to play while this occurs, and the user can manually navigate to now-playing interface 400, e.g., using now-playing button 340.

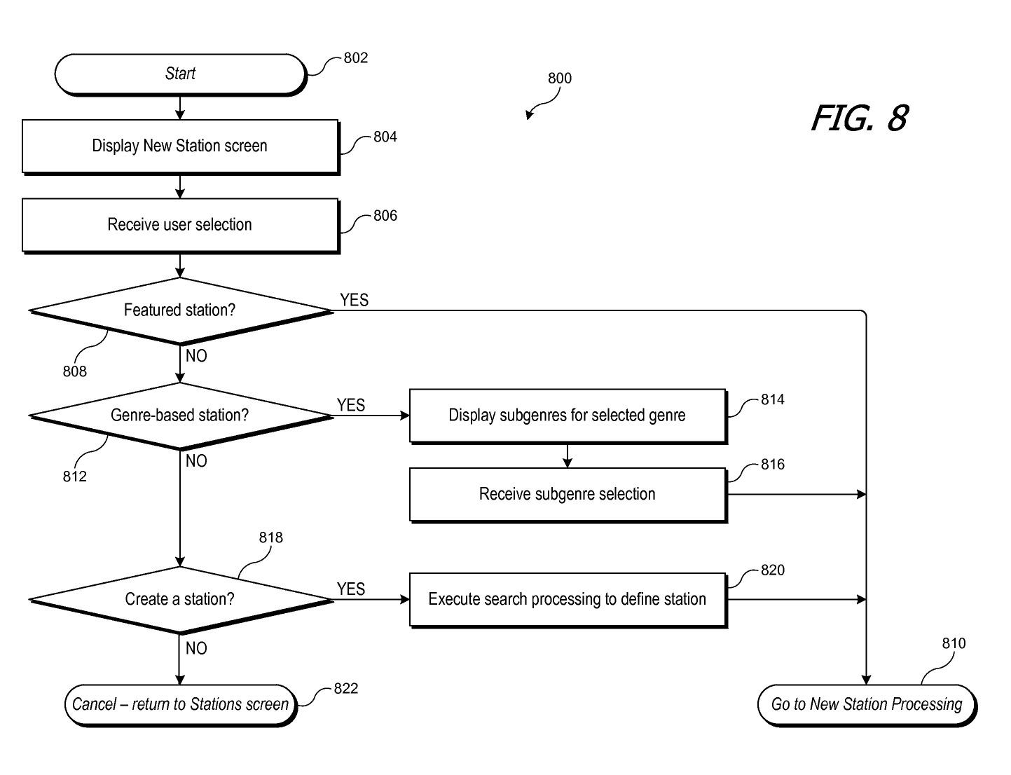

FIG. 8 is a flow diagram illustrating a process 800 for station creation according to an embodiment of the present invention. Process 800 can be implemented, e.g., as executable program instructions in radio application 145.

Process 800 begins (start block 802) when the user indicates a desire to add a new station to the personal station list, e.g., by selecting new station control 332 in GUI 300 of FIG. 3. At block 804, process 800 can display a new station creation interface, e.g., interface 500 of FIG. 5. At block 806, process 800 can receive user input selecting an option from the new station creation interface.

At block 808, if the user selects a featured station (e.g., from region 502 of interface 500), process 800 can end at block 810, passing control to new station processing, an example of which is described below with reference to FIG. 10.

If, at block 808, the user does not select a featured station, process 800 continues. At block 812, if the user selects a genre-based station, e.g., by selecting a genre (or category) from region 520 in interface 500, then process 800 can display a customization interface at block 814 allowing the user to select one or more subgenres for the selected genre, e.g., interface 600 of FIG. 6. At block 816, process 800 can receive the user's selection(s) defining the station, and process 800 can end at block 810, passing control to new station processing.

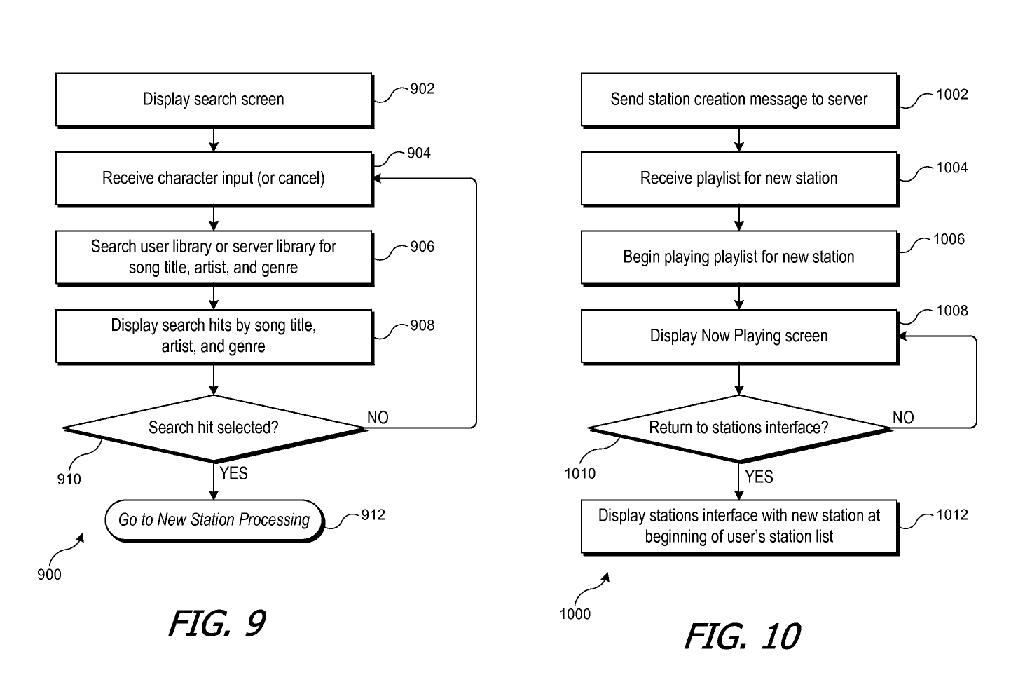

If, at block 812, the user does not select a genre-based station, process 800 continues to block 818 to determine whether the user selected the option to create a station (e.g., by activating button 536 in interface 500). If so, then search processing is executed at block 820. An example of search processing is described below with reference to FIG. 9. Once the search processing is completed, process 800 can end at block 810, passing control to new station processing.

If, at block 818, the user does not select the option to create a station, then the input event at block 806 can result in canceling the station creation process; accordingly, at block 822, process 800 can end without a new station being created. Ending process 800 at block 822 can include redisplaying GUI 300 or some other user interface screen as desired.

FIG. 9 is a flow diagram of a process 900 for searching a media library that can be implemented at block 820 of process 800 according to an embodiment of the present invention. At block 902, a search interface (e.g., interface 700 of FIG. 7) can be displayed. At block 904, character input can be received (or the user can cancel the search, in which case process 900 can end and control can pass to block 822 of FIG. 8). Assuming the search is not canceled, at block 906, the user's library or the server library can be searched for song titles, artist names, and/or genres that match the character input. As described above, searching can include sending queries to radio server 104 and/or searching the user's personal media library. At block 908, search results (hits) can be displayed, e.g., in regions 708, 710, and 712 of interface 700. At block 910, if the user selects one of the search hits, then at block 912, process 900 can end, and control can pass to new station processing. Rather than selecting a search hit, the user can continue to enter characters; accordingly, process 900 can return to block 904 to receive additional character input and update the search results.

FIG. 10 is a flow diagram of a process 1000 for new station processing according to an embodiment of the present invention. In some embodiments, process 1000 can be executed upon completion of process 800 at block 810 or of process 900 at block 912.

At block 1002, process 1000 can send a station creation message to radio server 104. This message can include information about the type of station created (e.g., featured, genre-based, or custom) and additional details appropriate to the type of station. For example, in the case of a featured station, the particular station can be identified; in the case of a genre-based station, the selected genre (and any subgenres or other categories or criteria that may have been selected) can be identified; in the case of a song-based or artist-based station, the selected song or artist can be identified.

Radio server 104 can use the received information to add the new station to the list of station definitions maintained for the user in user account data 154. In addition, radio server 104 can generate or retrieve a playlist for the new station, e.g., using station queue logic 154.

At block 1004, process 1000 can receive the playlist for the new station from radio server 104. At block 1006, process 1000 can initiate playing of the station, e.g., by requesting the audio stream for the first track on the playlist. At block 1008, process 1000 can transition the display to present a now-playing interface (e.g., interface 400 of FIG. 4), showing the track playing on the new station. At block 1010, process 1000 can determine whether to return to the stations interface (e.g., GUI 300 of FIG. 3). For example, process 1000 can detect user input navigating to the stations interface. When the user navigates to the stations interface, process 1000 can display GUI 300 with the new station appearing in the first position in the user's station list in region 322. In some embodiments, other interface screens may be displayed between displaying the now-playing interface at block 1008 and displaying the stations interface at block 1012.

It will be appreciated that processes 800, 900 and 1000 are illustrative and that variations and modifications are possible. Steps described as sequential may be executed in parallel, order of steps may be varied, and steps may be modified, combined, added or omitted. The display screens and interfaces can also be different from those described herein. A user can invoke process 800 any number of times to generate a personal stations list with an arbitrary number of stations; it is contemplated that a single user may define anywhere from zero to dozens or even hundreds of stations.

Certain embodiments can provide other interfaces for creating a new station to be added to the user's station list, as well as interfaces for customizing existing stations. Examples will now be described.

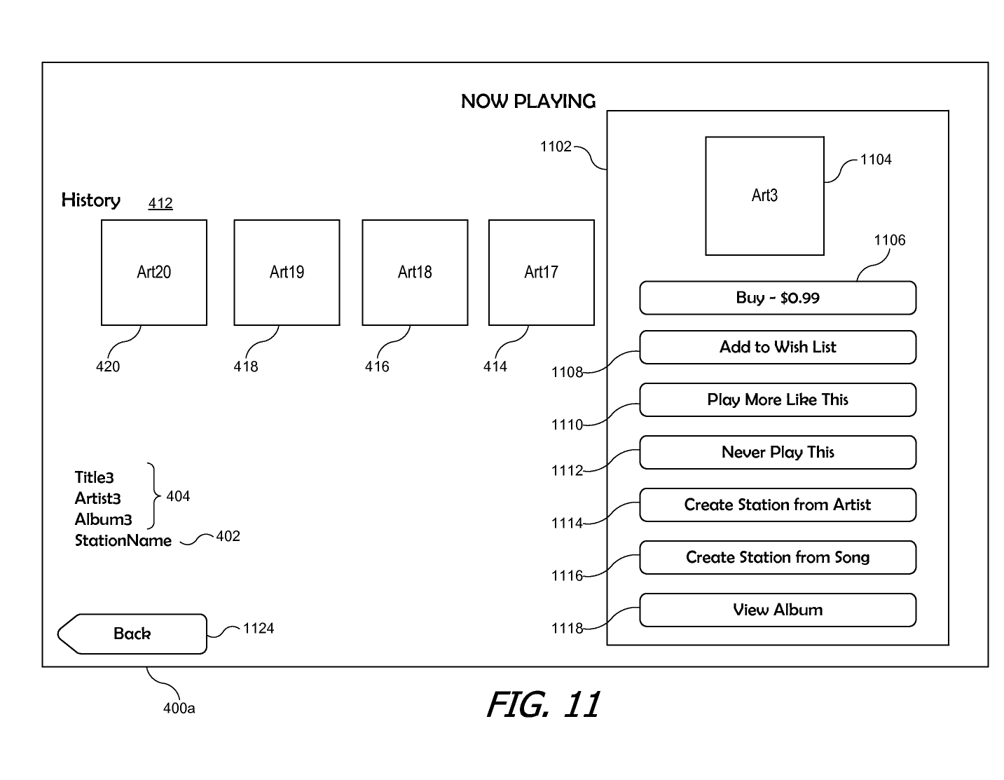

FIG. 11 illustrates an interface 400a that provides station creation and customization from a now-playing interface according to an embodiment of the present invention. Interface 400a in this example corresponds to interface 400 of FIG. 4 after the user has selected caret 422. As shown, selecting caret 422 causes an options menu 1102 to be displayed, overlaying the artwork for the current track. In some embodiments, menu 1102 can be a translucent overlay, or it can be opaque. Menu 1102 can occupy a different portion of the screen or the entire screen as desired. In some embodiments, while menu 1102 is displayed, progress bar 408 and/or other elements of now-playing interface 400 of FIG. 4 can disappear. Such changes can signal to the user that navigation has proceed to a deeper level; for example, back button 1124 may operate to return to now-playing interface 400 of FIG. 4.

Menu 1102 can include artwork 1104 for the currently playing track; artwork 1104 can be a reduced-size version of artwork 406 of FIG. 4. In addition, menu 1102 can provide options for interacting with the currently playing track, such as buy button 1106, wish-list button 1108, like button 1110, dislike button 1112, create station buttons 1114 and 1116, and view album button 1118.

Buy button 1108 allows the user to purchase the currently playing track, e.g., adding it to local media library 148. In general, radio system 100 is not limited to playing tracks the user owns, and the fact that a track is played on a station of radio system 100 does not give the user any additional rights to listen to the track. By selecting buy button 1108, the user can purchase rights to the track (e.g., rights to listen at any time and/or on any device owned or operated by the user).

For example, radio application 145 can interoperate with a media library management application on client device 102 (e.g., the iTunes® software provided by Apple Inc., assignee of the present application), which can interact with a media store platform (e.g., the iTunes Store operated by Apple Inc.). When a user actuates buy button 1108, radio application 145 can generate a purchase request to the media store platform, either directly or via the media library management program, and the media store platform can fulfill the purchase request. In some embodiments, the user credentials associated with a particular user by radio application 145 are the same as the credentials associated with that user by the media store platform, and this can facilitate seamless purchase of a track. Purchased tracks can be downloaded to the user's local media library 148. In some embodiments, the user's media library may be cloud-based, and downloading is not required; any process by which the user is granted rights to the track can be used to complete a purchase.

In some embodiments, buy button 1108 can display the actual price of the track. In other embodiments, the price can be displayed after the user actuates buy button 1108, and another user input (e.g., actuating a confirmation button or actuating buy button 1108 again) can be required to complete the purchase. If the user already owns a currently-playing track, buy button 1108 can be omitted from menu 1102 or replaced with another option (e.g., switching to view or play the track in the user's media library).

Wish list button 1108 allows the user to add the currently playing track to a “wish list” of tracks the user would like to own. The wish list can be maintained, e.g., on the media store platform. Similarly to purchase transactions, in embodiments where the user credentials associated with a particular user by radio application 145 are the same as the credentials associated with that user by the media store platform, this can facilitate seamless addition of a track to the user's wish list. In addition or instead, the user's wish list can be maintained by radio server 104 as part of user account data 154 or locally on client device 102.

Like button 1110 allows the user to customize the currently playing station by indicating that she wants to hear more tracks like the currently playing track on this station. Dislike button 1112 allows the user to customize the currently playing station by indicating that she does not want to hear the currently playing track again. In some embodiments, user feedback provided via buttons 1110 and 1112 can be sent to radio server 104, which can use the feedback to dynamically modify the station playlist for the currently playing station. For example, if the user actuates like button 1110, radio server 104 can identify various characteristics of the currently playing track and increase the weight given to those characteristics, or otherwise adjust an algorithm for constructing playlists, such that tracks similar to the liked track become more likely to be selected. If the user actuates dislike button 1112, radio server 104 can prevent the disliked track from appearing on the station's playlist in the future and can also adjust an algorithm for constructing playlists such that tracks similar to the disliked track are less likely to be selected. In some embodiments, like and dislike feedback can be applied on a per-station basis.

Create station buttons 1114 and 1116 allow the user to create a new station based on the currently playing track. For instance, in response to actuation of button 1114, radio application 145 can create a station using the artist of the currently playing track as a seed; in response to button 1116, radio application 145 can create a station using the currently playing track as a seed. Station creation can proceed in accordance with process 1000 described above or other similar processes, and the new station can begin playing, e.g., with the current track continuing to play as the first track of the new station's playlist. In some embodiments, when the new station is created, now playing interface 400a can revert to interface 400 of FIG. 4 (overlay 1102 is removed), except that station name 402 is replaced with the name of the new station.

Create buttons 1114 and 1116 can provide a convenient way for a user to create new stations on the fly while listening to content of interest. While the resulting station may be the same as a station created using search interface 700 of FIG. 7, using create buttons 1114 and 1116 allows the user to bypass typing in a query, making station creation fast and simple.

View album button 1118 allows the user to view the album of which the currently playing track is a part. For example, the media store platform described above can be invoked to present the album as it appears in the store and give the user the option to purchase the entire album or individual tracks. In some embodiments, if the user already owns the album, actuating view album button 1118 can allow the user to view the album in an interface to her personal media library.

It is to be understood that the particular controls shown for menu 1102 are illustrative, and that different controls and/or combinations of controls can be used in addition to or instead of those shown. For example, a user may be able to view other information related to the track, such as a biography or discography of the artist, song lyrics, upcoming tour dates, and so on. User feedback can use binary like and dislike options as shown, ratings (e.g., on a scale of 1 to 5), and/or other options to influence future song selections. In some embodiments, the user can indicate whether feedback should apply to a specific station or across all stations generated for the user. In some embodiments, individual user feedback might not affect song selection for a featured station (where the content is preprogrammed), but user feedback regarding such stations can be aggregated across multiple users, and such feedback can affect song selection.

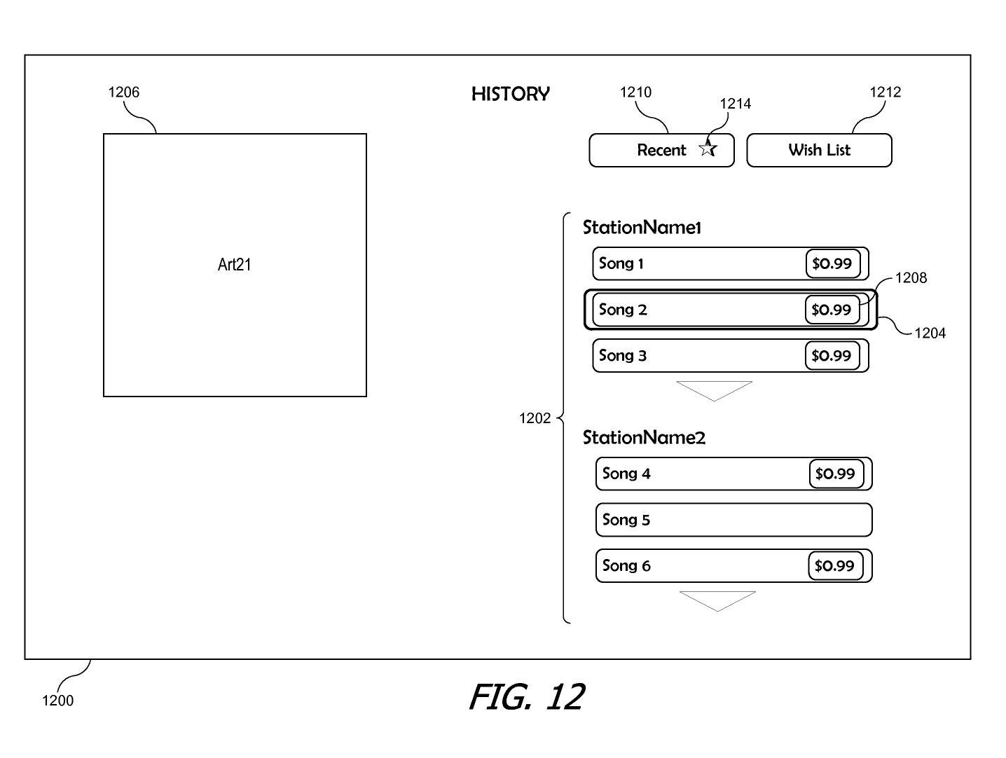

In some embodiments, a user can also interact with previously played tracks while viewing track history. FIG. 12 illustrates a history interface 1200 according to an embodiment of the present invention. A user can navigate to history interface 1200, e.g., by selecting history button 334 in GUI 300, or by selecting an icon from history region 412 of now-playing interface 400.

Region 1202 (on the right) presents a list of tracks the user has listened to, grouped by station. Tracks can be displayed, e.g., in reverse chronological order. Each station's track list can be scrollable, and region 1202 can be scrolled to view history data for additional stations. Thus, the size of the history list is not constrained by the available space in region 1202. In some embodiments, the user can also view a single history list that presents all tracks played (e.g., in reverse chronological order) without grouping by station. In such cases, the information for each track can identify the station on which the track was played.

The user can navigate through the history list in region 1202 to select different tracks. A currently selected track is indicated by highlight 1204. Artwork 1206 corresponding to the currently selected track can be displayed and can change as different tracks are selected. History interface 1200 can be viewed while another track is playing, and selecting tracks in region 1202 does not result in the selected track being played.

Each track can be presented together with a buy button 1208, which the user can actuate to purchase the track. The operation can be similar to buy button 1106 described above. If the user already owns a particular track, buy button 1208 can be omitted or replaced with another control element, such as an option to allow the user to play the track from her personal media library.

History information can be persistent or not, as desired. In some embodiments, history information can be cleared when radio application 145 exits, and when radio application 145 restarts, history region 1202 would be empty. In other embodiments, history information can be persistently stored, and history information from a previous listening session can be presented when radio application 145 restarts. For example, radio application 145 can store the information in local persistent storage on client device 102 and/or periodically transmit information identifying recently-played tracks to radio server 104, which can store the information with other user account data 152. Radio server 104 can also maintain a list of tracks it has streamed to client device 102 for the user, and radio application 145 need not provide history data to radio server 104. Where history information is persistently stored, initializing radio application 145 can include retrieving history information from persistent storage and obtaining artwork and other data to populate history region 1202; alternatively, history information can be retrieved when the user navigates to history interface 1200.

Records of any number of previously-played tracks can be kept. In some embodiments, history region 1202 can be scrolled to view (and purchase) previously played tracks that are not initially visible in region 1202, e.g., tracks from additional stations. In some embodiments, the history list for each station is also independently scrollable. Any number of tracks can be presented in history region 1202, either simultaneously or via scrolling. In keeping with the radio metaphor, some embodiments do not allow a user to select a track from history region 1202 for playback; however, a user may be able to preview (listen to an excerpt from) a track in the history list. In embodiments where the user has a media library, radio application 145 may allow the user to select a track that is in the user's media library from history region 1202 and thereby invoke a media application to play the selected track from the user's media library.

In the embodiment shown, the user can also use history interface 1200 to access her wish list. For example, selecting recent button 1210 can cause region 1202 to display a list of recently played tracks, while selecting wish list button 1212 can cause region 1202 to display tracks on the user's wish list. Wish-list tracks can be sorted or grouped by station or organized in any other manner as desired. Icon 1214 or other indicia (e.g., color changes) can be used to indicate which option is currently selected. Wish list data can be stored in persistent storage on client device 102, at radio server 104, or at a media store and can be retrieved from the appropriate source on request.

In some embodiments, the user can also access a menu of options for interacting with tracks in the history list. For example, the user can press and hold a select button on an input device, or the user can navigate the cursor to artwork 1206 and select the artwork. In some embodiments, a caret similar to caret 422 of FIG. 4 can be provided, and the user can select the caret (not shown in FIG. 11) to access the options menu.

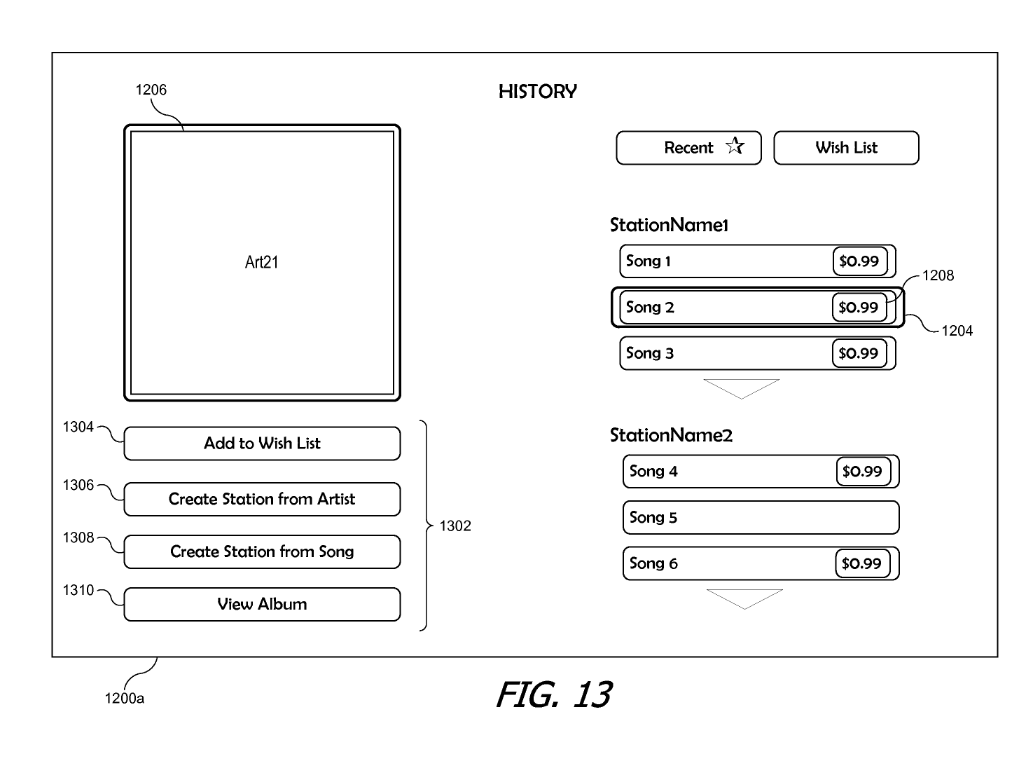

FIG. 13 illustrates a history interface 1200a showing an options menu 1302 according to an embodiment of the present invention. In this example, options menu 1302 is a popup that appears below artwork 1206 when the user selects artwork 1206. In this example, options menu 1302 includes a wish list button 1304, create station buttons 1306, 1308, and view album button 1310. These buttons can operate similarly to corresponding buttons described above with reference to FIG. 11. As with menu 1102 described above, the particular controls shown for menu 1302 are illustrative, and different controls and/or combinations of controls can be used in addition to or instead of those shown. For example, a user may be able to view other information, such as a biography or discography of the artist, song lyrics, upcoming tour dates, and so on. A buy option can be included in menu 1302 in addition to or instead of buy button 1208.

It will be appreciated that the history screens of FIGS. 12 and 13 are illustrative and that variations and modifications are possible. History lists can be arranged in any order desirable, and some embodiments may provide options for searching within the history list, e.g., by track title, artist, date played, or the like.

As noted above, a user can have a personal media library, which can be stored locally on client device 102 or in the cloud (e.g., at any location accessible via network 106 of FIG. 1). In some embodiments, a user can create stations based on tracks in her personal media library, with the stations being played using radio application 145. The user can access personal media library using a media management application (e.g., the iTunes® media management application provided by Apple Inc.), which can be distinct from radio application 145 but capable of communicating with radio application 145 using interprocess communication techniques. Alternatively, management of streaming media and the user's personal media library can be integrated into a single application.

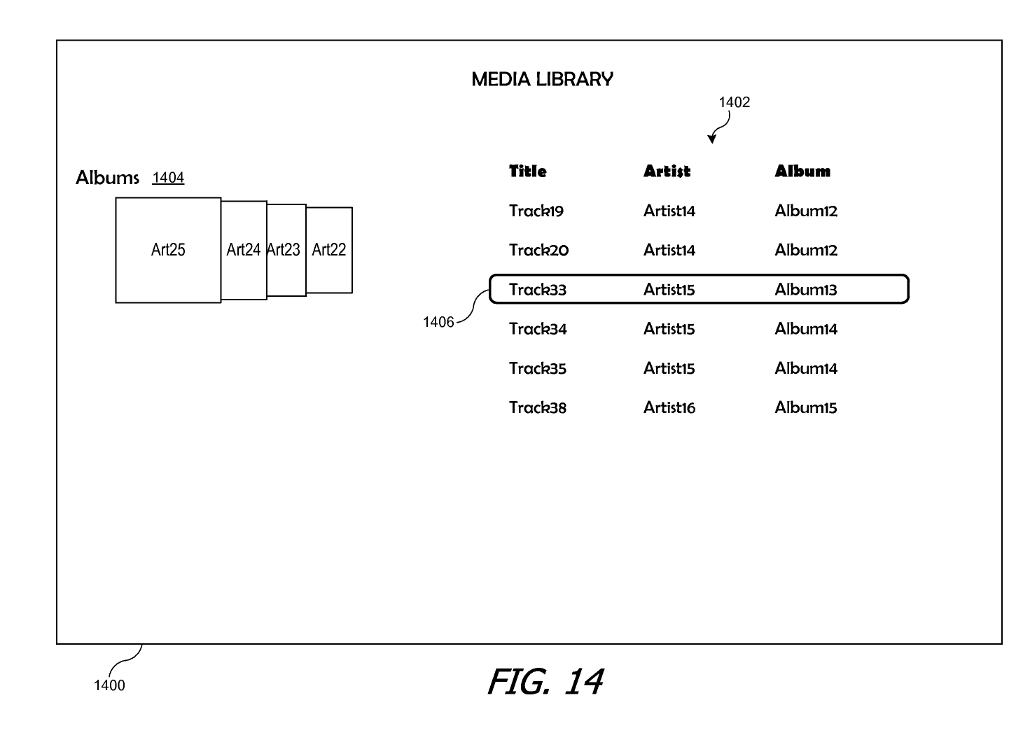

By way of illustration, FIG. 14 illustrates an interface 1400 for a media management application according to an embodiment of the present invention. Interface 1400 can include a list 1402 of tracks from the user's personal media library and other graphical elements such as album collection 1404. Like other lists illustrated herein, list 1402 can be a scrollable list, and the length of list 1402 is not constrained by the available display area.

List 1402 can be displayed as a result of various operations within the media management application. For example, the media management application may present a default view listing all of the tracks in the user's media library. The user can sort, search or browse the list in various ways, e.g., sorting by title, artist, album, genre or the like; searching for a particular keyword in all fields or particular fields; scrolling the list (before and/or after sorting or searching), and so on. In addition, the media management application may allow the user to define playlists containing tracks from the user's media library, and the user may view the list of tracks for a particular playlist. Accordingly, interface 1400 should be understood as generally illustrative of any listing 1402 of some or all of the tracks in a user's media library.

A user can navigate to select particular tracks in list 1402, e.g., by moving cursor 1406 up and down the list. In some embodiments, album collection 1404 can shuffle or otherwise be rearranged as cursor 1406 moves so that the album corresponding to the selected track is most prominently displayed.

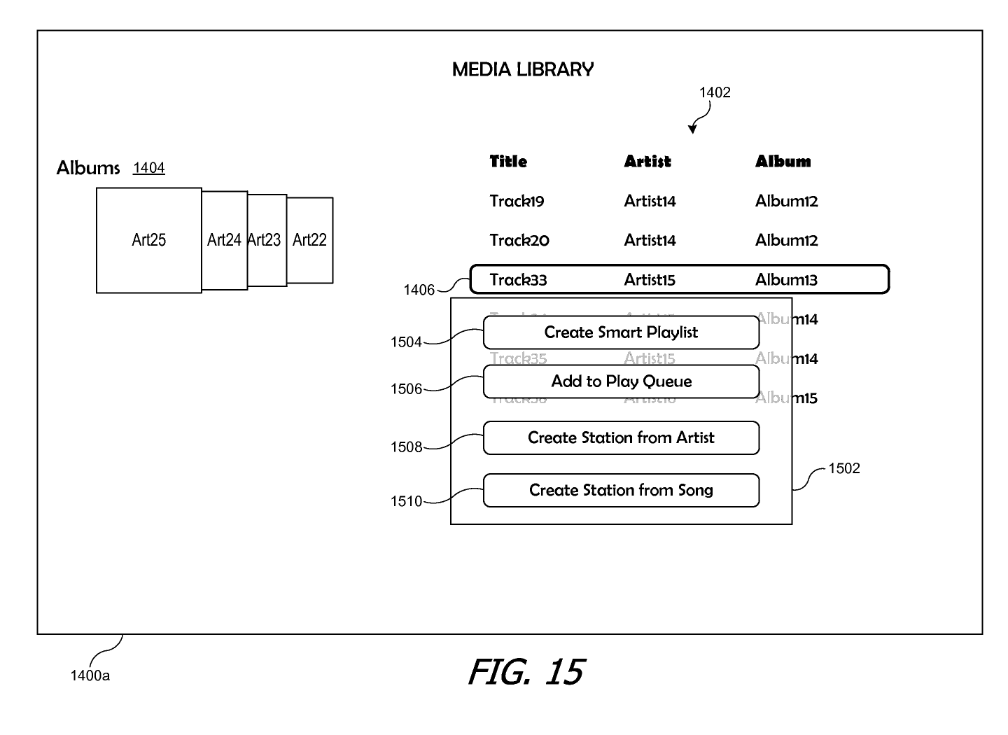

While a particular track is selected, the user can operate an input control (e.g., holding down a select button on an input device such as a remote control) to access an overlay menu of options for interacting with the track. FIG. 15 illustrates interface 1400a, which corresponds to interface 1400 after the user has accessed the overlay menu. Accordingly, interface 1400a includes overlay menu 1502, which can appear in a transparent or translucent overlay over part of list 1402 or elsewhere on the screen as desired.

Overlay menu 1502 can provide various options for interacting with the selected track. For example, overlay menu 1502 can include smart playlist button 1504, play queue button 1506, and station creation buttons 1508, 1510.

Smart playlist button 1504 and play queue button 1506 exemplify operations that can be performed by the media management application without the involvement of radio application 145. For instance, actuating smart playlist button 1504 can invoke a process within the media management application that generates a playlist of tracks from the user's media library that have some similarity to the selected track. Actuating play queue button 1506 can instruct the media management application to add the selected track to a queue of tracks to be played. Other operations supported by the media management application can also be made accessible via pop-up menu 1502.

Station creation buttons 1508 and 1510 exemplify operations that can involve cooperation between the media management program and radio application 145. Actuating button 1508 or 1510 can cause the media management application to invoke radio application 145 to create a streaming media station based on the selected track of the user's media library.

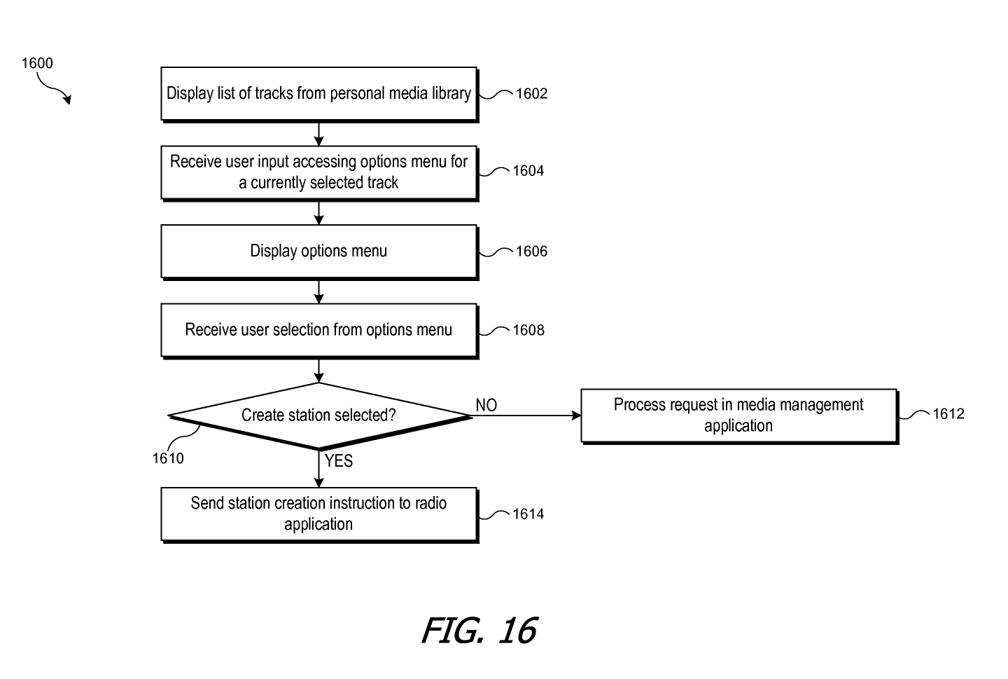

FIG. 16 is a flow diagram of a process 1600 for creating a media station based on a track in a user's personal media library according to an embodiment of the present invention. At block 1602, the media management application can display an interface that includes a list of tracks from the user's personal media library, e.g., interface 1400 of FIG. 14.

At block 1604, the media management application can receive user input requesting an overlay menu for a selected track. At block 1606, the media management application can display the overlay, e.g., overlay menu 1502 of FIG. 15. At block 1608, the media management application can receive user input selecting an action from the overlay menu.

At block 1610, the media management application determines whether the selected action includes station creation. If not, then at block 1612, the media management application can process the request. For example, if a user selects smart playlist button 1504 or play queue button 1506, the media management application can execute appropriate processes without invoking radio application 145.

If, at block 1610, the selected action does include station creation, then at block 1614, the media management application can send a station creation instruction to radio application 145. For example, the instruction can include track-identifying information for the selected track and an indication as to whether the station should use the track or the artist as the seed (which can be determined based on whether the user selected button 1508 or 1510 in overlay menu 1502). Radio application 145 can process the instruction, e.g., by creating a station using the selected track or artist as a seed.

Station creation can proceed similarly to process 1000 of FIG. 10. In some embodiments, radio application 145 can become a foreground process and begin to play the new station. For example, media management interface 1500 can be replaced with now-playing interface 400 of radio application 145. Where radio application 145 begins playing the new station upon creation, playing of the station can begin with playing the seed track from the user's media library, then transitioning to playing streamed content from radio server 104. In some embodiments, if the seed track was playing at the time the station is created, play can continue without interruption, providing a seamless transition from playing media from the user's library to playing streamed content.

In other embodiments, radio application 145 does not immediately begin playing the new station. Instead, radio application 145 can operate as a background process to instruct radio server 104 to add information defining the new station to user account data 152, and the new station will appear in GUI 300 the next time radio application 145 is accessed by the user. As described above, the new station can be added to the beginning of the station list so that it is initially visible in user-defined stations region 322.

Process 1600 and the media management application interfaces are illustrative and can be modified. While interaction with a media management application is not required for a radio application, providing such interaction can establish yet another path by which a user can define a station and explore media content related to her personal media library.

Certain embodiments of the present invention also allow a user to modify the user-defined stations list, providing further customization. By way of illustration, a user viewing the stations list in region 322 of GUI 300 of FIG. 3 can select a station to be edited, e.g., by placing a cursor over the corresponding station icon (e.g., icon 326) and holding a selection button.

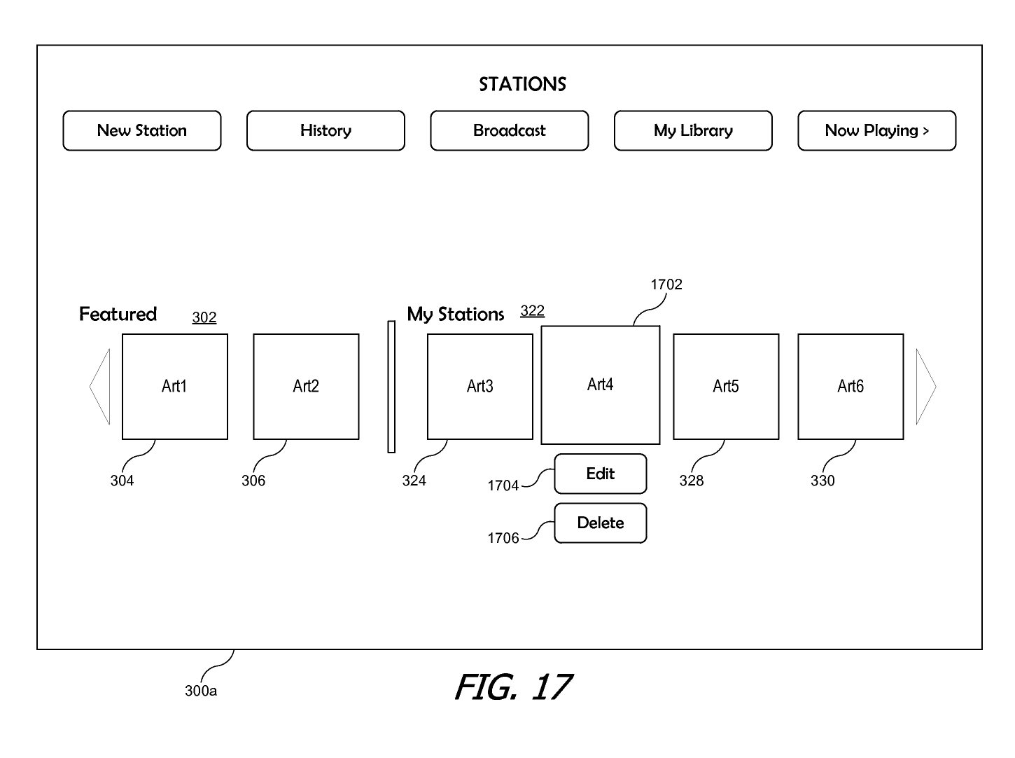

In response, GUI 300 can be modified to indicate that the selected station is now editable. For example, FIG. 17 illustrates GUI 300a after the user has selected icon 326 for editing. Icon 1702 can be an enlarged or otherwise modified version of icon 326 of FIG. 3. In some embodiments, icon 1702 can appear to jiggle or pulse or otherwise indicate that it is in an editable state.

In addition, editing menu options can appear. For example, edit button 1704 can be actuated to access a station editing menu. This menu (not shown) can allow the user to change the station name, view and modify lists of liked and disliked tracks associated with the station, and so on. Delete button 1706 can be actuated to delete the station from the user-defined stations list. Deleted stations no longer appear in region 322; for example, if the user actuates delete button 1706, icon 1702 can disappear from the display (along with edit button 1704 and delete button 1706), and the remaining icons can shift to close the gap. It is noted that in the case where the user deletes a featured station that was previously added to the user's station list, any customizations associated with the featured station may be lost.

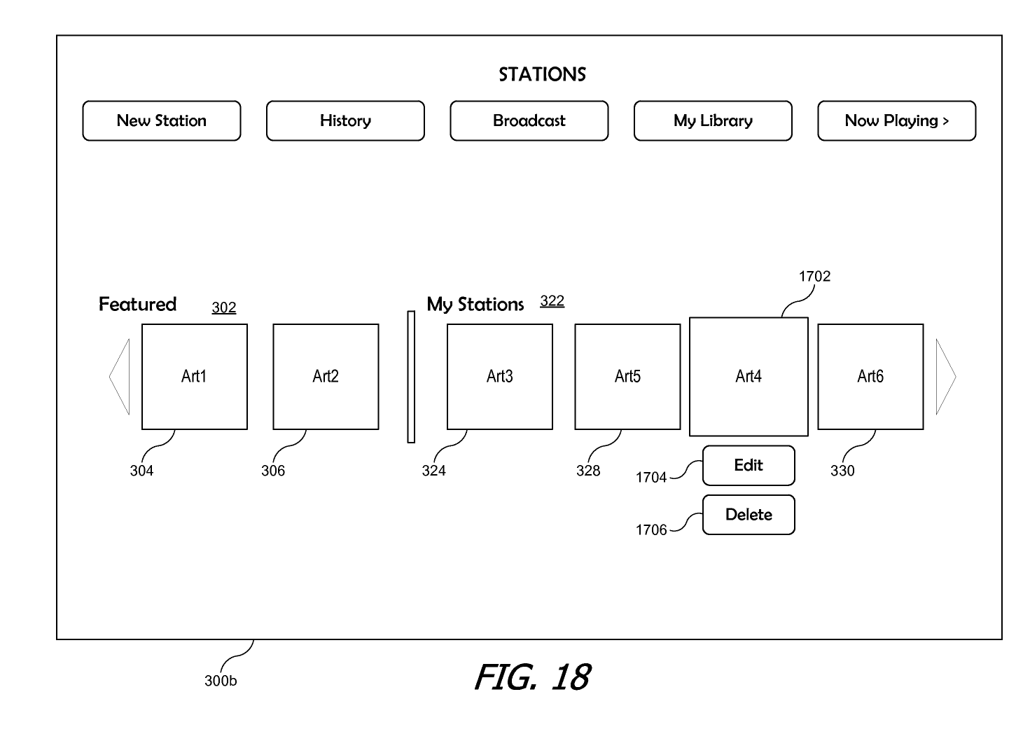

GUI 300a can also allow the user to rearrange the icons in region 322. For example, while icon 1702 is in the editable state, the user can perform a dragging operation to move icon 1702 to the left or right. As icon 1702 moves, other icons can move around it, allowing its position to be changed. FIG. 18 illustrates GUI 300b after the user has dragged icon 1702 one position to the right. As can be seen, icon 1702 has traded positions with icon 328, while icons 324 and 330 remain in their previous positions. Edit and delete buttons 1704, 1706 can move along with icon 1702. Icon 1702 can be dragged as far as desired, then released in its new position.

The editing mode can be exited in various ways. For example, if the user accesses an editing menu using edit button 1704, exiting that menu may also exit the editing mode. If the user deletes a station, this can also result in exiting the editing mode. Releasing an icon that is being dragged results in exiting the editing mode. Upon exiting the editing mode, the icon for the station that was being edited (e.g., icon 1702) can revert to its normal size (i.e., same size as icons 324, 328, etc.), assuming it has not been deleted, and editing menu options 1704 and 1706 can disappear.

Embodiments described herein provide interfaces for customizing a streaming media application to incorporate a personalized stations list defined by a user. For example, a user can create stations based on categories (e.g., genres or other characteristics), specific artists, and/or specific tracks. The user can select categories, artists, or tracks to be used for defining a station via a number of options, such as by searching or browsing a radio service's library of tracks; by selecting a currently playing or previously played track; and/or by selecting a track from a user's personal media library. Stations that a user has defined can be further customized based on user feedback, and stations on the user's personal stations list can be edited, deleted, and/or rearranged as the user sees fit.

As described above, a computing device (e.g., a client device operable by a user) can display a graphical interface that includes a group of graphical elements (e.g., station icons) associated with remotely stored streaming media data (e.g., various stations). The user can select an element associated with a category (e.g., a genre or other characteristic of media tracks). In response, the device can provide media stream options associated with the category including an option to add one or more new media streams (e.g., create a station) and/or to further refine the definition by specifying subcategories and/or other characteristics. If the user opts to add a media stream, a new media stream associated with the category can be added to a media stream collection associated with the user (e.g., the user's personal stations list).

In some embodiments, the computing device can display a graphical interface that includes a group of graphical elements associated with a user's personal media library, which can include locally stored media data and/or cloud-based media data in any combination. When the user selects one of the graphical elements (e.g., a track from the user's library), the device can present to the user one or more media stream options, including an option to add a new media stream associated with remotely stored streaming media data based on the selected graphical elements. These options can be presented in an overlay menu or the like. If the user opts to add the new media stream, a new media stream associated with the remotely stored streaming media data can be added to a media stream collection maintained for the user.

In some instances, the user can select the option to add the new media stream while the media data from the local source is being presented to the user. Where this occurs, upon adding a new media stream, the computing device can transition from presenting remotely stored streaming media data associated with the new media stream. The transition can be seamless; for example, the computing device can continue playing the track from the locally stored data, then begin presenting remotely stored streaming data at the end of the track.

When a new media stream is added, the new stream can begin playing without waiting for further user input. Whenever the user next views a list of available media streams, the list can include the new stream.

In some embodiments, the user can also view and interact with history data related to previously streamed media content, and the interaction can include adding a new media stream based on an element of previously streamed media content (e.g., a particular track or characteristics of a particular track).

While the invention has been described with respect to specific embodiments, one skilled in the art will recognize that numerous modifications are possible. For example, embodiments described above show particular GUI layouts with icons arranged in a horizontal row in some instances (e.g., station browsing) and vertical columns in others (e.g., history browsing); however, different arrangements can be substituted, e.g., horizontal for vertical, or other arrangements such as two-dimensional grids. Arrangements and labeling of elements can be varied, and different controls or combinations of controls can be used.

Using interfaces described herein or similar interfaces, a user can create any number of stations or media streams. In some instances, a user may create multiple stations from the same seed (e.g., same song; same artist; and/or same set of characteristics, categories or subgenres). In such instances, the stations can initially be identical to each other; however, they can diverge due to subsequent further customization, e.g., via the use of like/dislike or other feedback mechanisms and/or through station editing.

The description refers to “artwork” used as a visual indicator of what is playing or was previously played on various stations. As used herein, artwork can include any type of image or visual indicator. For instance, in some embodiments, artwork can include all or part of an album cover or other image associated with the track, the artist, an album of which the track is part, or anything else. Text elements can also be used as artwork in addition to or instead of graphical elements; for example, the track title, artist name, album name or the like can be displayed.

The description also refers to playlists associated with various stations and describes playlists being generated at a server and transmitted to the client device. In some instances, the device can receive a playlist for a station and use the playlist to request specific tracks to be streamed while the station is playing, as well as to request associated artwork. In other instances, the device can simply request the next track for a particular station and receive track-identifying information and associated artwork along with the media content. Thus, it is not necessary to deliver a playlist to the client device; the server can generate playlists and stream each track in turn. The playlist can be as long as desired; for instance, the server can generate a succession of one-track playlists for a station as each track is played or generate a longer playlist for the station and refer to that playlist when selecting tracks to play.

In some embodiments described above, it is assumed that the radio application obtains all audio and artwork from a radio server via a network. Some embodiments can use other sources in addition to or instead of the radio server. For example, a different remote server may provide audio and/or artwork via a network. As another example, in some instances, some or all of the audio and/or artwork may be stored in a user's media library on the client device or in a local cache. In such instances, the radio application can obtain audio and/or artwork from these sources.

In addition, while the description makes specific reference to radio and to audio tracks, those skilled in the art will appreciate that similar interfaces can be used in connection with presentation of other media, such as video. For example, a video-channel selection interface incorporating virtual channels can be provided, e.g., as a pop-up overlay over a currently playing video, in one region of a screen while the current video plays in a different region, or on a secondary display device (e.g., a remote control device) while the current video plays on a primary display device (e.g., a TV screen). A user can define and customize video channels in a manner analogous to that described above for audio.

The description also makes reference to embodiments where a user has a media library. In such instances, the user's media library can be stored locally on the client device, or it can be stored remotely, e.g., in the cloud, and accessed by the client device based on a user account or the like. In some embodiments, the same user account or credentials can be associated with both the streaming media application and the user's cloud-based media library, to facilitate seamless interoperation with both.

Embodiments of the present invention can be realized using any combination of dedicated components and/or programmable processors and/or other programmable devices. The various processes described herein can be implemented on the same processor or different processors in any combination. Where components are described as being configured to perform certain operations, such configuration can be accomplished, e.g., by designing electronic circuits to perform the operation, by programming programmable electronic circuits (such as microprocessors) to perform the operation, or any combination thereof. Further, while the embodiments described above may make reference to specific hardware and software components, those skilled in the art will appreciate that different combinations of hardware and/or software components may also be used and that particular operations described as being implemented in hardware might also be implemented in software or vice versa.

Computer programs incorporating various features of the present invention may be encoded and stored on various computer readable storage media; suitable media include magnetic disk or tape, optical storage media such as compact disk (CD) or DVD (digital versatile disk), flash memory, and other non-transitory media. Computer readable media encoded with the program code may be packaged with a compatible electronic device, or the program code may be provided separately from electronic devices (e.g., via Internet download or as a separately packaged computer-readable storage medium).

Thus, although the invention has been described with respect to specific embodiments, it will be appreciated that the invention is intended to cover all modifications and equivalents within the scope of the following claims.

What is claimed is:

1. A method comprising:
displaying, on a computing device, a graphical interface including a group of graphical elements associated with remotely stored streaming media data;
receiving input corresponding to a selection of a graphical element associated with a category;
providing one or more media stream options associated with the category including an option to add one or more new media streams; and
receiving input corresponding to a selection of a media stream option, wherein a new media stream associated with the category is added to a media stream collection.

2. The method of claim 1 wherein providing one or more media stream options includes generating one or more new stream views, and wherein a media stream view includes one or more media stream options.

3. The method of claim 2 wherein the one or more media stream views include inter-related selections, wherein one media stream view includes a list view icon, and wherein activating the list view icon causes the addition of a graphical element associated with a new media stream.

4. The method of claim 1 wherein the new media stream is featured, and wherein featuring includes displaying historical streaming media data for that new media stream.

5. The method of claim 1 wherein graphical elements have associated media streams that are continuously streamed.

6. A method comprising:
displaying, on a computing device, a graphical interface including a group of graphical elements associated with locally stored media data;
receiving input corresponding to a selection of a graphical element;
presenting one or more media stream options including an option to add a new media stream associated with remotely stored streaming media data; and
receiving input corresponding to a selection of a media stream option wherein a new media stream associated with remotely stored streaming media data is added to a media stream collection.

7. The method of claim 6 wherein the one or more media stream options are displayed in a media stream overlay.

8. The method of claim 6 wherein the selected graphical element has associated media data that originates from the locally stored media data, wherein the option to add the new media stream is presented while the associated media data is being presented to the user, and wherein adding a new media stream includes transitioning from presenting the locally stored media data to presenting remotely stored streaming media data associated with the new media stream.

9. The method of claim 8 wherein the transition between the locally stored media data and the remotely stored streaming media data is uninterrupted.

10. The method of claim 6 wherein providing one or more media stream options includes generating one or more new stream views, and wherein a media stream view includes one or more media stream options.

11. The method of claim 10 wherein the one or more media stream views include inter-related selections, wherein one media stream view includes a list view icon, and wherein activating the list view icon causes the addition of a graphical element associated with a new media stream.

12. The method of claim 6 wherein the new media stream is featured, and wherein featuring includes displaying historical streaming media data for that new media stream.

13. The method of claim 6 wherein graphical elements have associated media streams that are continuously streamed.

14. A computer system comprising:
a user input device;
a display driver;
a network interface to receive media streams; and
a processor coupled to the user input device, the display driver, and the network interface, the processor being configured to:
generate a graphical interface image for the display driver, the graphical interface image including a group of graphical elements associated with remotely stored streaming media data;
receive a first input from the user input device, the first input corresponding to a selection of a graphical element associated with a category;
update, in response to the first input, the graphical interface image to provide one or more media stream options associated with the category including an option to add one or more new media streams; and
receive a second input from the user input device, the second input corresponding to a selection of a media stream option, wherein a new media stream associated with the category is added to a media stream collection.

15. The computer system of claim 14 wherein the processor is further configured such that updating the graphical user interface to provide one or more media stream options includes generating one or more media stream views, and wherein a media stream view includes one or more media stream options.

16. The computer system of claim 14 wherein the category corresponds to a genre of music.

17. The computer system of claim 14 wherein the processor is further configured to begin streaming media for the new media stream in response to receiving the second input.

18. A computer system comprising:
a user input device;
a display driver;
a local store to store media data;
a network interface to receive media streams; and
a processor coupled to the user input device, the display driver, and the network interface, the processor being configured to:
generate a graphical interface image for the display driver, the graphical interface image including a group of graphical elements associated with locally stored media data;
receive a first input from the user input device, the first input corresponding to a selection of one of the graphical elements from the group of graphical elements;
update, in response to the first input, the graphical interface image to present one or more media stream options including an option to add a new media stream associated with remotely stored streaming media data; and
receive a second input from the user input device, the second input corresponding to a selection of one of the one or more media stream options wherein a new media stream associated with remotely stored streaming media data is added to a media stream collection.

19. The computer system of claim 18 wherein the selected graphical element has associated media data that originates from the locally stored media data, wherein the option to add the new media stream is presented while the associated media data is being presented to the user, and wherein the processor is further configured to transition from presenting the locally stored media data to presenting remotely stored streaming media data associated with the new media stream in response to the second input.

20. The computer system of claim 19 wherein the transition between the locally stored media data and the remotely stored streaming media data is uninterrupted.
